(19) United States
(12) Patent Application Publication
(10) Pub. No.: US 2024/0090504 A1
(43) Pub. Date: Mar. 21, 2024

(54) DITHIOCARBAMATE FUNGICIDE COMPOSITION

(71) Applicant: Adama Makhteshim Ltd., Beer Sheva (IL)

(72) Inventors: Venkateswararao Yadagani, Pragathis Nagar, Hyderabad (IN); Alexander Tolts, Beer Sheva (IL)

(73) Assignee: Adama Makhteshim Ltd., Beer Sheva, DE (IL)

(21) Appl. No.: 18/255,502

(22) PCT Filed: Dec. 2, 2021
(86) PCT No.: PCT/IB2021/061261

§ 371 Date: Jun. 9, 2023

Related U.S. Application Data
(60) Provisional application No. 63/194,343, filed on May 28, 2021.

(30) Foreign Application Priority Data
Dec. 2, 2020 (IN) 202011052575

(51) Int. Cl. A01N 47/14; A01N 25/04; A01N 43/16; A01N 43/40; A01N 43/653; A01P 3/00

(52) U.S. Cl. CPC A01N 47/14; A01N 25/04; A01N 43/16; A01N 43/40; A01N 43/653; A01P 3/00

(57) ABSTRACT

The present invention relates to compositions and delivery systems comprising (1) a macromolecular complex comprising a dithiocarbamate fungicide and a polyelectrolyte, (2) an azole fungicide, and (3) an aqueous carrier. The invention further relates to methods for using and processes for preparing said compositions and delivery systems.

### CROSS-REFERENCE TO RELATED APPLICATIONS

This application claims benefit of Indian Provisional Application No. 202011052575, filed Dec. 2, 2020, and of U.S. Provisional Application No. 63/194,343, filed May 28, 2021, the contents of each of which are hereby incorporated by reference.

Throughout this application various publications are referenced. The disclosures of these documents in their entireties are hereby incorporated by reference into this application in order to more fully describe the state of the art to which this invention pertains.

### 1. FIELD

The present invention relates to compositions and delivery systems comprising (1) a macromolecular complex comprising a dithiocarbamate fungicide and a polyelectrolyte, (2) an azole fungicide, and (3) an aqueous carrier. The invention further relates to methods for using and processes for preparing said compositions and delivery systems.

### 2. INTRODUCTION

Agricultural pest control includes means of biological control such as crop rotation, companion planting, breeding of pest-resistant cultivars, the use of living organisms such as dogs to catch rodents, the use of physical traps such as sticky flypapers and garden guns, and the application of chemical control agents. Chemical control agents are toxic to the pests involved while causing little or no toxic effects to the agricultural plants. Chemical control agents or pesticides include lime and wood ash, sulphur, bitumen, nicotine, heavy metals such as copper, lead and mercury, and neem oil.

Chemical control agents can be incredibly beneficial and have contributed to increased food production over the past century. However, when a pesticide is applied, it may be carried into the environment by leaching into the soil or drifting through the air. In addition, pesticide exposure to humans sometimes may cause adverse health effects ranging from simple irritation of the skin and eyes to more severe effects such as affecting the nervous system. A major challenge in agriculture, therefore, is to control plant pests while reducing the amounts of chemical control agents that are applied.

Combination of mancozeb with other fungicide may increase the efficacy of the active agent and reduce resistance of the pest to the active agent. Known formulations of mancozeb and other fungicide(s) use organic carrier(s). There is a need to develop compositions which reduces the use of organic liquids.

### 3. SUMMARY OF THE INVENTION

The present invention provides a composition comprising (1) a polyelectrolyte, (2) a dithiocarbamate fungicide, and (3) at least one agriculturally acceptable carrier.

The invention also provides a process for producing composition of the present invention, the process comprises preparing a suspension concentrate composition comprising the dithiocarbamate fungicide and combining the suspension concentrate composition with the azole fungicide.

The invention also provides a process for producing composition of the present invention, the process comprises preparing a suspension concentrate composition comprising the dithiocarbamate fungicide and combining the suspension concentrate composition with a strobilurin fungicide.

The invention also provides a method of treating a plant, or a part of a plant, against a pathogen, comprising contacting the plant, part of the plant, locus of the pathogen, soil, and/or an area in which pest infestation is to be prevented with any one of the combinations, compositions, and/or delivery systems described herein.

The invention also provides a method of increasing crop yield comprising contacting the plant, part of the plant, locus of the pathogen, soil, and/or an area in which pest infestation is to be prevented with any one of the combinations, compositions, and/or delivery systems described herein.

The invention also provides a method of improving plant vigor comprising contacting the plant, part of the plant, locus of the pathogen, soil, and/or an area in which pest infestation is to be prevented with any one of the combinations, compositions, and/or delivery systems described herein.

### 4. DETAILED DESCRIPTION

### 4.1 Definitions

Unless defined otherwise, all technical and scientific terms used herein have the meaning commonly understood by persons of ordinary skill in the art to which this subject matter pertains.

The term “a” or “an”, as used herein, includes the singular and the plural, unless specifically stated otherwise. Therefore, the terms “a,” “an,” or “at least one” can be used interchangeably in this application.

As used herein, the term “about” when used in connection with a numerical value includes ±10% from the indicated value. In addition, all ranges directed to the same component or property herein are inclusive of the endpoints, are independently combinable, and include all intermediate points and ranges. It is understood that where a parameter range is provided, all integers within that range, and tenths thereof, are also provided by the invention. For example, “30-45%” includes 30%, 30.1%, 30.2%, etc. up to 45%.

The term “polyelectrolyte”, as is used herein, refers to a molecule consisting of a plurality of functional, charged groups that are linked to a polymer backbone. In the context of this application, the term “polycation” is interchangeable with the term “positively charged polyelectrolyte”.

The term “macromolecular complex”, as is used herein, refers to structure that is formed by non-covalent interaction of a dithiocarbamate fungicide with a polyelectrolyte, such as at least one polycation. In such macromolecular complex, the non-covalent interactions are preferably electrostatic interactions. The macromolecular complex thus avoids the use of covalent cross-linkers, as disclosed in PCT/IB2020/055089.

The term “electrostatic interaction” as is used herein, refers to electric force between any two charged molecules and/or dipole molecules. The term “electrostatic interactions” includes ionic interactions, hydrogen bonds, and van der Waals forces such as dipole-dipole interactions.

The term “free”, as is used herein in connection with a dithiocarbamate fungicide, refers to a dithiocarbamate fungicide that is not part of a macromolecular complex. A free dithiocarbamate fungicide is a non-complexed form of the dithiocarbamate fungicide.

As used herein, the term “lignin compound” refers to a chemical compound that is derived from naturally occurring lignin or lignen by a process that includes sulphonation. The resulting sulfonic acids are strong acids and lignin compounds are therefore negatively charged at pH values below 7.

As used herein, the term “chitosan” refers to a linear polysaccharide composed of randomly distributed β-(1-4)-linked D-glucosamine (deacetylated unit) and N-acetyl-D-glucosamine (acetylated unit). Chitosan is produced by deacetylation of chitin. The term “chitosan” includes chitosan, chitosan derivatives and mixtures of chitosan and chitosan derivatives.

The term “crop”, as is used herein, include cereals such as wheat, barley, rye, oats, sorghum and millet, rice, cassava and maize, and crops that produce, for example, peanut, sugar beet, cotton, soya, oilseed rape, potato, tomato, peach and vegetables.

The term “part of a plant”, as is used herein, indicates a part of a plant including, but not limited to, pollen, ovule, leaf, root, flower, fruit, stem, bulb, corn, branch and seed.

The term “bioactive ingredient”, as is used herein with connection to an additional bioactive ingredient, refers to a chemical substance capable of controlling pests and/or killing living organisms. Bioactive ingredients are commonly used in medicine, agriculture, forestry, and in industry where they prevent the fouling of, for example, water, agricultural products including seed, and oil pipelines. A bioactive ingredient can be a pesticide, including a fungicide, herbicide, insecticide, algicide, molluscicide, miticide and rodenticide; and/or an antimicrobial such as a germicide, antibiotic, antibacterial, antiviral, antifungal, antiprotozoal and/or antiparasitic compound.

The term “bioactive ingredient”, as is used herein in connection with a macromolecular complex and/or complex of the present invention, is a dithiocarbamate fungicide. The dithiocarbamate fungicide may be a part of the macromolecular complex and/or complex of the present invention.

As used herein, the term “pest” includes, but is not limited to, insect, nematode, weed, fungi, algae, mite, tick, and animal. Said pest preferably is a phytopathogenic fungi, an unwanted insect, and/or a weed.

As used herein, the term “weed” refers to any unwanted vegetation.

As is used herein, the term “pesticide” includes, but is not limited to, a herbicide, insecticide, fungicide, nematocide, mollusks repellent and a control agent.

The terms “controlling a pest” and “pest control”, as used herein, refers to preventive, persistence, curative and/or knock down treatment of a pest.

The term “polyene fungicide”, as used herein, refers to a polyene macrolide antifungal that possess antifungal activity such as natamycin, lucensomycin, filipin, nystatin or amphotericin B, most preferred natamycin. Derivatives of a polyene fungicide, such as derivatives of natamycin, are also included. A preferred derivative is a salt or a solvate of a polyene fungicide and/or a modified form of a polyene fungicide such as e.g. different shaped crystal forms such as the needle-shaped crystal of natamycin described in U.S. Pat. No. 7,727,966.

The term “suspension concentrate”, as used herein, refers to a suspension of solid particles in a liquid intended for dilution with water prior to use. In some embodiments, suspension concentrate refers to an aqueous suspension concentrate.

The term “suspo-emulsion” refers to a dispersion of solid particles and oil-organic solvent drops in water intended for dilution with water prior to use.

Presence of a dithiocarbamate fungicide as one of the constituents of a macromolecular complex significantly enhances the biological efficacy and improves persistence of the dithiocarbamate fungicide, when compared to a non-complexed dithiocarbamate fungicide, as described in PCT/IB2020/055089.

It was found that dithiocarbamate fungicide that is provided in a macromolecular complex is also more compatible with azole fungicide in aqueous carrier, compared to dithiocarbamate fungicide that is not provided in a macromolecular complex according to the invention.

A composition according to the invention further has improved physical properties, different morphology and particle size, as demonstrated for example by electron microscopy, when compared to a free dithiocarbamate fungicide, preferably mancozeb.

### 4.2 Combinations, Mixtures and Compositions

The present invention provides a combination of (i) a macromolecular complex comprising a dithiocarbamate fungicide and a polyelectrolyte, and (ii) an azole fungicide.

In some embodiments, the combination further comprises a strobilurin fungicide.

Dithiocarbamate fungicides, azole fungicides and strobulurin fungicides that may be used in connection with the present invention are described herein below.

In some embodiments, the combination further comprises a carboxamide fungicide.

In some embodiments, the carboxamides fungicide is an SDHI fungicide

In some embodiments, the SDHI fungicide is fluxapyroxad.

In some embodiments, the combination further comprises an SDHI fungicide

In some embodiments, the combination further comprises a morpholine fungicide. In some embodiments, morpholine fungicide is fenpropidin.

In some embodiments, the combination is a mixture.

In some embodiments, the mixture is a tank mix.

In some embodiments, the combination comprises at least one additional agriculturally acceptable additive.

In some embodiments, the combination is a composition comprising (1) a macromolecular complex comprising a dithiocarbamate fungicide and a polyelectrolyte, (2) an azole fungicide, and (3) an aqueous carrier.

In some embodiments, the combination is a composition comprising (1) a macromolecular complex comprising a dithiocarbamate fungicide and a polyelectrolyte, (2) an azole fungicide, (3) an aqueous carrier, and (4) an organic phase.

In some embodiments, the combination is a composition comprising (1) a macromolecular complex comprising a dithiocarbamate fungicide and a polyelectrolyte, (2) at least one additional fungicide, (3) an aqueous carrier, and (4) an organic phase.

In some embodiments, the combination is a composition comprising (1) a macromolecular complex comprising a dithiocarbamate fungicide and a polyelectrolyte, (2) at least one additional fungicide and (3) an aqueous carrier.

In some embodiments, the composition further comprises at least one additional fungicide.

In some embodiments, the composition comprises (1) a macromolecular complex comprising a dithiocarbamate fungicide and a polyelectrolyte, (2) an azole fungicide, and (3) an aqueous carrier, wherein the dithiocarbamate fungicide and the azole fungicide are suspended in the aqueous carrier.

In some embodiments, the composition further comprises an organic phase. In some embodiments, the composition comprises an organic phase which comprises a water-immiscible carrier.

In some embodiments, the organic phase is oil-organic solvent drops.

In some embodiments, the composition comprises at least one additional fungicide which is dissolved in the water-immiscible carrier.

In some embodiments, the composition comprises (1) a macromolecular complex comprising a dithiocarbamate fungicide and a polyelectrolyte, (2) an azole fungicide, (3) an aqueous carrier, and (4) an organic phase comprising water immiscible carrier, wherein the dithiocarbamate fungicide is suspended in the aqueous carrier and the azole fungicide is dissolved in the water-immiscible carrier

In some embodiments, the composition comprising an aqueous carrier and water-immiscible carrier is a suspoemulsion.

In some embodiments, the composition comprising at least one additional fungicide which is suspended in the aqueous carrier.

In some embodiments, the composition comprises at least one additional fungicide which is dissolved in the water-immiscible carrier.

In some embodiments, the composition comprises at least two additional fungicides which are suspended in the aqueous carrier.

In some embodiments, the composition comprising at least two additional fungicide which are dissolved in the water immiscible carrier

In some embodiments, the dithiocarbamate fungicide is suspended, and the triazole fungicide, strobilurin, morpholine fungicide and/or carboxamides fungicide are emulsified in the composition.

In some embodiments, the dithiocarbamate fungicide and at least one of the additional fungicides such as strobilurin, morpholine fungicide and/or carboxamides fungicide are suspended in the composition.

In some embodiments, the dithiocarbamate fungicide is suspended and the azole fungicide and at least one of the additional fungicides such as strobilurin, morpholine fungicide and/or carboxamides fungicide are emulsified in the composition.

In some embodiments, the composition further comprises a strobilurin fungicide In some embodiments, the composition further comprises an SDHI fungicide.

In some embodiments, the composition further comprises a morpholine fungicide.

In some embodiments, the azole fungicide is triazole fungicide.

The triazole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole and prothioconazole.

The strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin and fluoxastrobin.

In a preferred embodiment, the subject matter relates to a composition comprising: a) mancozeb, suspended in an aqueous carrier; and b) tebuconazole and picoxystrobin, dissolved in the water immiscible carrier.

In another preferred embodiment, the subject matter relates to a composition comprising: a) mancozeb, suspended in an-aqueous carrier; and b) prothioconazole and picoxystrobin, dissolved in the water immiscible carrier.

In another preferred embodiment, the subject matter relates to a composition comprising: a) mancozeb, suspended in an-aqueous carrier; and b) prothioconazole, dissolved in the water immiscible carrier.

In a preferred embodiment, the subject matter relates to a composition comprising: a) mancozeb, tebuconazole and picoxystrobin suspended in an aqueous carrier.

In another preferred embodiment, the subject matter relates to a composition comprising: a) mancozeb, prothioconazole and picoxystrobin suspended in an-aqueous carrier.

In another preferred embodiment, the subject matter relates to a composition comprising: a) mancozeb and prothioconazole suspended in an-aqueous carrier.

Agriculturally acceptable additives that may be used in connection with the present invention are described herein below.

The compositions of the present invention are stable. Stability may be assessed using methods as described in the Examples provided herein below.

The present invention provides a composition comprising any one of the combinations, including mixtures, described herein, and an aqueous carrier.

The present invention provides a composition comprising (1) a polyelectrolyte, (2) a dithiocarbamate fungicide, and (3) at least one agriculturally acceptable carrier.

In some embodiments, the composition comprises at least one additional active ingredient, preferably an additional insecticide, fungicide and/or herbicide.

In some embodiments, the composition comprises at least two additional active ingredients, preferably independently chosen from an additional insecticide, fungicide and/or herbicide.

In some embodiments, the composition comprises at least three additional active ingredients, preferably independently chosen from an additional insecticide, fungicide and/or herbicide. In some embodiments, all additional active ingredients are suspended in the aqueous carrier.

In some embodiments, one and/or two and or three of the additional active ingredients are suspended in the aqueous carrier.

In some embodiments, all additional active ingredients are dissolved in the water-immiscible carrier.

In some embodiments, one and/or two and/or three of the additional active ingredients are dissolved in the water-immiscible carrier.

In some embodiments, the mancozeb is combined with an SDHI and a strobilurin fungicide.

In some embodiments, the mancozeb is combined with a morpholine fungicide and an SDHI.

In some embodiments, the mancozeb is combined with a morpholine fungicide and a strobilurin fungicide.

In some embodiments, the mancozeb is combined with a morpholine fungicide and an azole fungicide. In some embodiments, the composition comprises mancozeb, an SDHI fungicide and a strobilurin fungicide.

In some embodiments, the composition comprises mancozeb, a morpholine fungicide and an SDHI fungicide.

In some embodiments, the composition comprises mancozeb, morpholine fungicide and a strobilurin fungicide.

In some embodiments, the composition comprises mancozeb, a morpholine fungicide and an azole fungicide.

In some embodiments, the polyelectrolyte is a polycation.

In some embodiments, the composition comprises a macromolecular complex comprising the polycation and the dithicarbamate fungicide, wherein the macromolecular complex is characterized by intermolecular, non-covalent interactions, preferably electrostatic interactions such as ionic interactions, hydrogen bonds and van der Waals forces, such as dipole-dipole interactions, between the polycation and the dithiocarbamate fungicide.

In some embodiments, the macromolecular matrix is substantially free or free of polyanion.

In some embodiments, the dithiocarbamate fungicide is in a macromolecular complex with a polycation.

In some embodiments, the macromolecular complex is characterized by intermolecular, non-covalent interactions between the polycation and the dithiocarbamate fungicide. In some embodiments, the macromolecular complex is characterized by intermolecular, non-covalent interactions between donor and acceptor groups of the polycation and the dithiocarbamate fungicide.

In some embodiments, the intermolecular, non-covalent interactions are electrostatic interactions.

In some embodiments, the electrostatic interactions are ionic interactions, hydrogen bonds and van der Waals forces.

In some embodiments, the macromolecular complex is characterized by ionic interactions between donor and acceptor groups of the polycation and the dithiocarbamate fungicide. In some embodiments, the intermolecular, non-covalent interactions between the polycation and the dithiocarbamate fungicide are ionic interactions.

In some embodiments, the van der Waals forces are dipole-dipole interactions between the polycation and the dithiocarbamate fungicide.

In some embodiments, molecules of the dithiocarbamate fungicide are entirely complexed with molecules of the polycation by electrostatic interaction prior to application. In some embodiments, molecules of the dithiocarbamate fungicide are partially complexed with molecules of the polycation prior to application. In some embodiments, molecules of the dithiocarbamate fungicide are entirely encapsulated within the polycation to form a macromolecular complex prior to application. In some embodiments, molecules of the bioactive ingredient which is dithiocarbamate fungicide are partially encapsulated within the polycation to form a macromolecular complex prior to application.

In some embodiments, at least 20% of the molecules of the dithiocarbamate fungicide are complexed by electrostatic interaction with the molecules of the polycation prior to application.

In some embodiments, at least 20% of the molecules of the dithiocarbamate fungicide are encapsulated within the polycation to form the complex prior to application.

In some embodiments, the dithiocarbamate fungicide is a dimethyldithiocarbamate. In some embodiments, the dimethyldithiocarbamate is ferbam (iron(III) dimethyldithiocarbamate), ziram (zinc dimethyldithiocarbarnate), thiram (dimethylcarbamothioylsulfanyl-N,N-dimethyldithiocarbamate), propineb (zinc propylenebis(dithiocarbamate), or an ethylenebisdithiocarbamate.

A preferred dithiocarbamate is or comprises an ethylene bisdithiocarbamate (EBDC) such as sodium ethylenebisdithiocarbamate (nabam), zinc ammoniate ethylenebis(dithiocarbamate)-poly(ethylenethiuram disulfide) (metiram). A more preferred EBDC is in the form of a complex with manganese (maneb), zinc (zineb) or, most preferably, a combination of manganese and zinc (mancozeb; zinc; manganese(2+); N-[2-(sulfidocarbothioylamino)ethyl]carbamodithioate or [[2-[(dithiocarboxy)amino]ethyl]carbamodithioato(2−)-κS,κS′]manganese mixture with [[2-[(dithiocarboxy) amino]ethyl]carbamodithioato (2−)-κS,κS′]zinc). A preferred dithiocarbamate in a macromolecular complex of the invention is mancozeb.

In some embodiments, the dithiocarbamate fungicide is mancozeb. Mancozeb tech. available commercially contains mancozeb and inert additives. In some embodiments, the mancozeb tech. contains 86.7% w/w of mancozeb. When the mancozeb tech. contains 86.7% w/w of mancozeb and the composition comprises a 37% w/w of mancozeb tech., the composition comprises 32% w/w of mancozeb.

In some embodiments, the dithiocarbamate fungicide is a mixture of two dithiocarbamate fungicides.

In some embodiments, the batch of dithiocarbamate fungicide is a mixture of the dithiocarbamate fungicide and at least one additive. In some embodiments, the batch of dithiocarbamate fungicide is a mixture of the dithiocarbamate fungicide and a stabilizer. In some embodiments, the stabilizer is an anionic surfactant. In some embodiments, the stabilizer is lignosulfonate calcium. In some embodiments, the anionic surfactant is sodium lignosulfonate. In some embodiments, the anionic surfactant is calcium lignosulfonate.

A non-bioactive polycation preferably is or comprises cationic starch, poly(allylamine), chitosan, a chitosan derivative such as thiolated chitosan, 5-methyl-pyrrolidinone-chitosan, and chitosan oligosaccharide, epsilon-p-L-lysine, DEAE-dextran, or mixtures thereof, to form a macromolecular complex with a dithiocarbamate fungicide, preferably with mancozeb. Preferably, said non-bioactive polycation is selected from the group consisting of cationic starch, poly(allylamine), chitosan and chitosan derivatives. Preferably, said non-bioactive polycation is poly(allylamine). Preferably, said non-bioactive polycation is chitosan. In some embodiments, the polycation is chitosan (CTS), epsilon-poly-L-lysine (ϵ-PLL), poly allyl amine (PAA), or any combination thereof. In some embodiments, the polycation is chitosan (CTS). In some embodiments, the polycation is poly allyl amine (PAA). In some embodiments, the polycation is epsilon-poly-L-lysine (ϵ-PLL).

Preferred bioactive macromolecular complexes according to the invention comprising a dithiocarbamate fungicide are formed by chitosan or chitosan derivatives and mancozeb, poly(allylamine) and mancozeb, cationic starch and mancozeb, and/or DEAE-dextran and mancozeb. The electrostatic attraction between the protonated amino groups of the polycation and the negative charges of mancozeb is the main driving force in the formation of such macromolecular complexes. Preferred bioactive macromolecular complexes according to the invention comprising a bioactive ingredient are formed by chitosan and mancozeb. Preferred bioactive macromolecular complexes according to the invention comprising a bioactive ingredient are formed by poly(allylamine) (PAA) and mancozeb.

In some embodiments, the weight ratio between the polycation and the dithiocarbamate fungicide is between 1:50 to 1:100. In some embodiments, the ratio between the polycation and the dithiocarbamate fungicide is between 1:70 to 1:90. In some embodiments, the ratio between the polycation and the dithiocarbamate fungicide is about 1:80. In some embodiments, the ratio between the polycation and the dithiocarbamate fungicide is 1:78.4.

In some embodiments, the weight ratio between the polycation and the mancozeb is between 1:50 to 1:80. In some embodiments, the weight ratio between the polycation and the mancozeb is between 1:60 to 1:77. In some embodiments, the weight ratio between the polycation and the mancozeb is between 1:60 to 1:61.7. In some embodiments, the weight ratio between the polycation and the mancozeb is 1:63.3.

In some embodiments, the anionic surfactant is a lignin compound.

In some embodiments, the lignin compound is lignosulfonate. In some embodiments, the lignin compound is sodium lignosulfonate. In some embodiments, the lignin compound is calcium lignosulfonate.

In some embodiments, the macromolecular complex is substantially free of polyanion. In some embodiments, the macromolecular complex is free of polyanion.

In some embodiments, the macromolecular complex has a particle size d50 of less than 30 microns. In some embodiments, the macromolecular complex has a particle size d50 of between 4-30 microns. In some embodiments, the macromolecular complex has a particle size d50 of less than 2 microns. In some embodiments, the macromolecular complex has a particle size d50 of 0.5-1.5 microns. In some embodiments, the macromolecular complex has a particle size d50 of 1-2 microns. In some embodiments, the macromolecular complex has a particle size d50 of 1 micron. In some embodiments, the macromolecular complex has a particle size d50 of 1.5 micron. In some embodiments, the macromolecular complex has a particle size d50 of 2 microns.

In some embodiments, the macromolecular complex has a particle size d90 of 1-15 microns. In some embodiments, the macromolecular complex has a particle size d90 of between 5-10 microns. In some embodiments, the macromolecular complex has a particle size d90 of 9-10 microns. In some embodiments, the macromolecular complex has a particle size d90 of 9.5 microns. In some embodiments, the macromolecular complex has a particle size d90 of between 1-7 microns. In some embodiments, the macromolecular complex has a particle size d90 of between 3-5. microns. In some embodiments, the macromolecular complex has a particle size d90 of 4 microns. In some embodiments, the macromolecular complex has a particle size d90 of between 2-5 microns. In some embodiments, the macromolecular complex has a particle size d90 of 2-3 microns. In some embodiments, the macromolecular complex has a particle size d90 of 3.5 microns. In some embodiments, the macromolecular complex has a particle size d90 of 3 microns. In some embodiments, the macromolecular complex has a particle size d90 of 1-2 microns. In some embodiments, the macromolecular complex has a particle size d90 of 1.7 microns.

The particle size described herein is volume-based.

In some embodiments, the particle size is measured using laser diffraction.

In some embodiments, the macromolecular complex comprises a polyelectrolyte. In some embodiments, the polyelectrolyte is a polycation.

Said polyelectrolyte and the dithiocarbamate fungicide are preferably present in a macromolecular complex of the invention in a ratio between 1:5 and 1:100 (w/w), more preferred in a ratio between 1:6 and 1:100, more preferred in a ratio between 1:10 and 1:90, more preferred in a ratio between 1:60 and 1:100 (w/w), such as between 1:70 and 1:90.

The molar ratio between the dithiocarbamate fungicide and the polyelectrolyte preferably is between 300:1 and 5:1, such as between 250:1 and 140:1 and between 220:1 and 170:1 such as 174:1.

In some embodiments, the macromolecular complex comprises the polycation and the dithiocarbamate fungicide in a ratio between 1:5 and 1:300 (w/w).

In some embodiments, the macromolecular complex comprises the polycation and the dithiocarbamate fungicide in a ratio between 1:60 and 1:80 (w/w).

In some embodiments, the macromolecular complex between the polycation and the dithiocarbamate fungicide is in an aqueous solution.

In some embodiments, the polycation and the dithiocarbamate fungicide are mixed in an aqueous solution to form the macromolecular complex.

Said mixing preferably is performed under slightly acidic conditions. The positively charged polycations interact electrostatically with the dithiocarbamate fungicide to form a macromolecular complex.

In some embodiments, the macromolecular complex is made by pre-mixing the polycation and the dithiocarbamate fungicide.

The concentration of a polyelectrolyte in a composition according to the invention is preferably between 0.1 and 100 g/kg. In some embodiments, the concentration of the polycation in the composition is between 0.1 and 100 g/kg.

The concentration of the polyelectrolyte in a composition according to the invention is preferably 0.01-10% by weight based on the total weight of the stable composition, more preferably 0.1-5% by weight based on the total weight of the composition, such as 0.5-1.5% by weight based on the total weight of the composition.

In some embodiments, the concentration of the polycation in the composition is 0.01-10% by weight based on the total weight of the composition. In some embodiments, the concentration of the polycation in the composition is 0.1-5% by weight based on the total weight of the composition. In some embodiments, the concentration of the polycation in the composition is 0.1-1.5% by weight based on the total weight of the composition. In some embodiments, the concentration of the polycation in the composition is 0.1-1% by weight based on the total weight of the composition. In some embodiments, the concentration of the polycation in the composition is about 0.5% by weight based on the total weight of the composition. In some embodiments, the concentration of chitosan in the composition is about 0.5% by weight based on the total weight of the composition. In some embodiments, the concentration of the polycation in the composition is about 1% by weight based on the total weight of the composition. In some embodiments, the concentration of PAA in the composition is about 1% by weight based on the total weight of the composition.

The concentration of the dithiocarbamate fungicide in a composition according to the invention is preferably between 10 and 1000 g/L, more preferred between 100 and 500 g/L such as between 300 and 400 g/L. In some embodiments, the concentration of the dithiocarbamate fungicide in the composition is between 350 and 450 g/L. In some embodiments, the concentration of the dithiocarbamate fungicide in the composition is about 360 g/L. In some embodiments, the concentration of the dithiocarbamate fungicide in the composition is about 390-420 g/L. In some embodiments, the concentration of the dithiocarbamate fungicide in the composition is between 350 and 450 g/L.

The concentration of the dithiocarbamate fungicide in a composition according to the invention preferably is 10-80% by weight based on the total weight of the composition, more preferably 10-50% by weight based on the total weight of the composition, such as 25-40% by weight based on the total weight of the stable composition. In some embodiments, the concentration of the dithiocarbamate fungicide in the composition is 30-45% by weight based on the total weight of the composition. In some embodiments, the concentration of the dithiocarbamate fungicide in the composition is 30-40% by weight based on the total weight of the composition. In some embodiments, the concentration of the dithiocarbamate fungicide in the composition is 30-35% by weight based on the total weight of the composition. In some embodiments, the concentration of the dithiocarbamate fungicide in the composition is 35-40% by weight based on the total weight of the composition. In some embodiments, the concentration of the dithiocarbamate fungicide in the composition is 40-45% by weight based on the total weight of the composition. In some embodiments, the concentration of the dithiocarbamate fungicide in the composition is about 30% by weight based on the total weight of the composition. In some embodiments, the concentration of the dithiocarbamate fungicide in the composition is about 35% by weight based on the total weight of the composition. In some embodiments, the concentration of the dithiocarbamate fungicide in the composition is about 40% by weight based on the total weight of the composition. In some embodiments, the concentration of the dithiocarbamate fungicide in the composition is about 45% by weight based on the total weight of the composition.

In some embodiments, the weight ratio between the polycation and the dithiocarbamate fungicide is between 1:50 to 1:80. In some embodiments, the ratio between the polycation and the dithiocarbamate fungicide is between 1:60 to 1:77. In some embodiments, the ratio between the polycation and the dithiocarbamate fungicide is between 1:60 to 1:62. In some embodiments, the ratio between the polycation and the dithiocarbamate fungicide is 1:63.3.

In some embodiments, the weight ratio between the polycation and the mancozeb is between 1:50 to 1:80. In some embodiments, the ratio between the polycation and the mancozeb is between 1:60 to 1:77. In some embodiments, the ratio between the polycation and the mancozeb is between 1:60 to 1:61.7. In some embodiments, the ratio between the polycation and the mancozeb is 1:63.3.

In some embodiments, the aqueous carrier is water.

In some embodiments, the composition is a suspoemulsion and the aqueous carrier is water.

In some embodiments, the composition comprises 40-80% by weight of water. In some embodiments, the composition comprises 50-70% by weight of water. In some embodiments, the composition comprises 50-55% by weight of water. In some embodiments, the composition comprises 40-80% by weight of water. In some embodiments, the composition comprises about 51% by weight of water. In some embodiments, the composition comprises about 62% by weight of water.

In some embodiments, the azole fungicide is selected from the group consisting of tebuconazole, prothioconazole, and a combination thereof.

In some embodiments, the strobilurin fungicide is selected from group consisting of picoxystrobin, trifloxystrobin, azoxystrobin, pyraclostrobin, metominostrobin, metyltetraprole, mandestrobin and a combination thereof.

In embodiments, the QiI fungicide (Quinone inside Inhibitor) may include but is not limited to fenpicoxamid, cyazofamid, amisulbrom.

In some embodiments, the SDHI fungicide may include but is not limited to penthiopyrad, boscalid, flutolanil, fluxapyroxad, fluopyram, fluindapyr, benzodiflupyr, bixafen, Inpyrfluxam and pydiflumetofen.

In some embodiments, the SDHI fungicide is selected from group consisting of penthiopyrad, boscalid, flutolanil, fluxapyroxad, fluopyram, fluindapyr, benzodiflupyr, bixafen, Inpyrfluxam, pydiflumetofen and any combination thereof.

In some embodiments, the azole fungicide is selected from the group consisting of tebuconazole, prothioconazole, and a combination thereof.

In some embodiments, the concentration of the azole fungicide in the composition is 1-10% by weight based on the total weight of the composition. In some embodiments, the concentration of the azole fungicide in the composition is 2-3% by weight based on the total weight of the composition.

In some embodiments, the concentration of the tebuconazole in the composition is 1-10% by weight based on the total weight of the composition. In some embodiments, the concentration of the tebuconazole in the composition is 2-3% by weight based on the total weight of the composition.

In some embodiments, the concentration of the prothioconazole in the composition is 1-10% by weight based on the total weight of the composition. In some embodiments, the concentration of the prothiconazole in the composition is 2-3% by weight based on the total weight of the composition

In some embodiments, the concentration of the additional fungicide in the composition is 1-10% by weight based on the total weight of the composition. In some embodiments, the concentration of the additional fungicide in the composition is 2-3% by weight based on the total weight of the composition.

In some embodiments, the concentration of the strobilurin fungicide in the composition is 1-10% by weight based on the total weight of the composition. In some embodiments, the concentration of the strobilurin fungicide in the composition is 2-3% by weight based on the total weight of the composition.

In some embodiments, the composition comprises at least one additional agrochemical. In some embodiments, composition comprises the least one additional fungicide.

In some embodiments, at least one additional fungicide is selected from the group consisting of a strobilurin fungicide, a carboxamides fungicide, morpholines, QiI and any combination thereof.

In some embodiments, the carboxamides fungicide is an SDHI fungicide

In some embodiments, the SDHI fungicide is fluxapyroxad.

In some embodiments, the additional fungicides are selected from the group consisting of a strobilurin fungicide, an azole fungicides, a carboxamide fungicide, morpholine fungicide, QiI and any combination thereof.

In some embodiments, the carboxamides fungicide is an SDHI fungicide.

In some embodiments, the SDHI fungicide is fluxapyroxad.

In some embodiments, the morpholines fungicide may include but not limited to aldimorph, fenpropimorph, ridemorph, dodemorph, spiroxamine, piperalin, fenpropidin.

In some embodiments, the composition further comprises a strobilurin fungicide. In some embodiments, the strobilurin fungicide is selected from the group consisting of azoxystrobin, picoxystrobin. In some embodiments, the strobilurin fungicide is selected from the group consisting of picoxystrobin, azoxystrobin, and a combination thereof.

In some embodiments, the additional fungicide in the composition is fenpropidin. In some embodiments, the additional fungicide in the composition is difenoconazole. In some embodiments, the additional fungicide in the composition is tebuconazole. In some embodiments, the additional fungicide in the composition is prothioconazole. In some embodiments, the additional fungicides in the composition are prothioconazole and fluxapyroxad. In some embodiments, the additional fungicides in the composition are tebuconazole and fluxapyroxad. In some embodiments, the additional fungicides in the composition are difenoconazole and fluxapyroxad. In some embodiments, the additional fungicides in the composition are prothioconazole and picoxystrobin. In some embodiments, the additional fungicides in the composition are tebuconazole and picoxystrobin. In some embodiments, the additional fungicides in the composition are difenoconazole and picoxystrobin. In some embodiments, the additional fungicides in the composition are fenpropidin and picoxystrobin. In some embodiments, the additional fungicides in the composition are fenpropidin and fluxapyroxad. In some embodiments, the additional fungicides in the composition are prothioconazole and trifloxystrobin. In some embodiments, the additional fungicides in the composition are cyproconazole and azoxystrobin. In some embodiments, the additional fungicides in the composition are cyproconazole and picoxystrobin. In some embodiments, the additional fungicides in the composition are tebuconazole and picoxystrobin.

In some embodiments, the additional fungicides in the composition are prothioconazole and Azoxystrobin.

In some embodiments, the additional fungicides in the composition are prothioconazole and Trifloxystrobin.

In some embodiments, the additional fungicides in the composition are prothioconazole and Pyraclostrobin.

In some embodiments, the additional fungicides in the composition are Tebuconazol and Trifloxystrobin.

In some embodiments, the additional fungicides in the composition are Tebuconazol and Pyraclostrobin.

In some embodiments, the additional fungicides in the composition are Tebuconazol and Picoxystrobin.

In some embodiments, the additional fungicides in the composition are Ciproconazol and Picoxystrobin.

In some embodiments, the additional fungicides in the composition are Ciproconazol and Fluxapyroxade.

In some embodiments, the additional fungicides in the composition are Ciproconazol and Azoxystrobin.

In some embodiments, the additional fungicides in the composition are Ciproconazol and Trifloxystrobin.

In some embodiments, the additional fungicides in the composition are Ciproconazol and Pyraclostrobin.

In some embodiments, the additional fungicides in the composition are Difenoconazole and Picoxystrobin.

In some embodiments, the additional fungicides in the composition are Difenoconazole and Azoxystrobin.

In some embodiments, the additional fungicides in the composition are Difenoconazole and Trifloxystrobin.

In some embodiments, the additional fungicides in the composition are Difenoconazole and Pyraclostrobin.

In some embodiments, the combination is a composition comprising (1) a macromolecular complex comprising a dithiocarbamate fungicide and a polyelectrolyte, (2) at least one additional fungicide and (3) an aqueous carrier.

In some embodiments, the additional fungicide is selected from the group consisting of azole fungicides, strobilurin fungicides, morpholines, QiI fungicide, SDHI and any combination thereof.

In some embodiments, the composition comprising al least one additional fungicide which is dissolved in the water immiscible carrier.

In some embodiments, the composition comprising at least one additional fungicide which is suspended in the water carrier.

In some embodiments, the composition comprising at least two additional fungicide which are suspended in the water carrier.

In some embodiments, the composition comprising at least two additional fungicide which are dissolved in the water immiscible carrier.

In some embodiments, the composition comprising at least two additional fungicide which one is dissolved in the water immiscible carrier and one is suspended in the water carrier

In some embodiments, the azole fungicide is a triazole fungicide.

The azole fungicide may include but is not limited to azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, ipconazole, metconazole, myclobutanil, penconazole, propiconazole, simeconazole, tebuconazole, tetraconazole, triadimefon, triadimenol, triticonazole and prothioconazole.

The strobilurin fungicide may include but is not limited to azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, trifloxystrobin, dimoxystrobin, fenaminstrobin, metominostrobin, orysastrobin and fluoxastrobin.

In a preferred embodiment, the subject matter relates to a composition comprising: a) dithiocarbamate fungicide, prothioconazole and picoxystrobin suspended in the aqueous carrier.

In a preferred embodiment, the subject matter relates to a composition comprising: a) dithiocarbamate fungicide, tebuconazole and picoxystrobin suspended in the aqueous carrier.

In a preferred embodiment, the subject matter relates to a composition comprising: a) dithiocarbamate fungicide and prothioconazole suspended in the aqueous carrier.

In a preferred embodiment, the subject matter relates to a composition comprising: a) dithiocarbamate fungicide, suspended in the aqueous carrier and (b) prothioconazole and picoxystrobin dissolved in the water immiscible carrier.

In a preferred embodiment, the subject matter relates to a composition comprising: a) dithiocarbamate fungicide, suspended in the aqueous carrier (b) and tebuconazole and picoxystrobin dissolved in the water immiscible carrier.

In a preferred embodiment, the subject matter relates to a composition comprising: a) dithiocarbamate fungicide suspended in the aqueous carrier and prothioconazole dissolved in the water immiscible carrier.

In a preferred embodiment, the subject matter relates to a composition comprising: a) mancozeb, suspended in an aqueous carrier; and b) tebuconazole and picoxystrobin, dissolved in the water immiscible carrier.

In another preferred embodiment, the subject matter relates to a composition comprising: a) mancozeb, suspended in an-aqueous carrier; and b) prothioconazole and picoxystrobin, dissolved in the water immiscible carrier.

In another preferred embodiment, the subject matter relates to a composition comprising: a) mancozeb, suspended in an-aqueous carrier; and b) prothioconazole, dissolved in the water immiscible carrier.

In a preferred embodiment, the subject matter relates to a composition comprising: a) mancozeb, tebuconazole and picoxystrobin suspended in an aqueous carrier.

In another preferred embodiment, the subject matter relates to a composition comprising: a) mancozeb, prothioconazole and picoxystrobin suspended in an-aqueous carrier.

In another preferred embodiment, the subject matter relates to a composition comprising: a) mancozeb and prothioconazole suspended in an-aqueous carrier.

In an embodiment, the amount of the additional fungicide(s) may be present in a concentration of about 0.1-30 wt. %, based on the total weight of the composition. In a further embodiment, the amount of the additional fungicide(s) may be present in a concentration of about 1-15% by weight based upon the total weight of the composition. In another embodiment, the amount of the additional fungicide(s) may be present in a concentration of about 1-10% by weight based upon the total weight of the composition. In yet another embodiment, the amount of the additional fungicide may be present in a concentration of about 3-8% by weight based upon the total weight of the composition.

In some embodiments, water immiscible carrier may include but is not limited to aromatic hydrocarbons (e.g. toluene, o-, m-, p-xylene, ethylbenzene, isopropylbenzene, tert-butylbenzene, naphthalenes, mono- or polyalkyl-substituted naphthalenes), paraffins (e.g. octane, nonane, decane, undecane, dodecane, tridecane, tetradecane, pentadecane, hexadecane, hepta-decane, octa-decane, nona-decane, eicosane, heneicosane, docosane, tricosane, tetracosane, pentacosane, and branched chain isomers thereof), petroleum, ketones (e.g. acetophenone, cyclohexanone), vegetable oil (e.g. olive oil, kapok oil, castor oil, papaya oil, camellia oil, palm oil, sesame oil, corn oil, rice bran oil, peanut oil, cotton seed oil, soybean oil, rapeseed oil, linseed oil, tung oil, sunflower oil, safflower oil, tall oil), alkyl ester of vegetable oils, (e.g. rapeseed oil methyl ester or rapeseed oil ethyl ester, rapeseed oil propyl esters, rapeseed oil butyl esters, tall oil fatty acids esters), diesel, mineral oil, fatty acid amides (e.g. C₁-C₃ amines, alkylamines or alkanolamines with C₆-C₁₈ carboxylic acids), fatty acids, tall oil fatty acids, alkyl esters of fatty acids (e.g. C₁-C₄ monohydric alcohol esters of C₈ to C₂₂ fatty acids such as methyl oleate, ethyl oleate), modified vegetable oils and combinations thereof.

In a preferred embodiment, the water immiscible carrier may include but is not limited to aromatic hydrocarbons, fatty acid amides, alkyl ester of vegetable oils and vegetable oils.

In an embodiment, the amount of the water-immiscible carrier may be about 0.1-20 wt. %, about 1-15 wt. %, or about 0.1-10 wt. %, or about 1-5% based on the total weight of the composition.

In a specific embodiment, the water-immiscible carrier may be present in a concentration of about 9% by weight based upon the total weight of the composition.

In some embodiments, the composition comprises a water immiscible carrier which comprises the additional fungicide(s). In some embodiments, the composition comprises an organic phase. In some embodiments, the composition comprises an organic phase which comprises a water immiscible carrier, and the water immiscible carrier comprises the additional fungicide(s). In some embodiments, the additional fungicide(s) is dissolved in the water immiscible carrier. In some embodiments, the additional fungicide(s) is suspended in the water immiscible carrier. In some embodiments, the additional fungicide(s) is suspended in the aqueous carrier.

In some embodiments, the weight ratio between the mancozeb and the azole fungicide is between 20:1 to 1:1. In some embodiments, the weight ratio between the mancozeb and the azole fungicide is between 15:1 to 10:1. In some embodiments, the weight ratio between the mancozeb and the azole fungicide is about 10:1. In some embodiments, the weight ratio between the mancozeb and the azole fungicide is 32:3.

In some embodiments, the weight ratio between the mancozeb and azole fungicide and additional fungicide is 32:3:2.3.

In some embodiments, the composition comprises mancozeb and prothioconazole.

In some embodiments the composition comprises mancozeb, picoxystrobin and tebuconazole.

In some embodiments, the composition comprises mancozeb, picoxystrobin and prothioconazole.

In some embodiments, the composition further comprises a carboxamides fungicide.

In some embodiments, the carboxamides fungicide is an SDHI fungicide.

In some embodiments, the SDHI fungicide is fluxapyroxad.

In some embodiments, the composition further comprises amorpholines fungicide.

In some embodiments, the morpholines fungicide is fenpropidin.

In some embodiments, the composition further comprises at least one additional fungicide. In some embodiments, the composition comprises an azole fungicide. In some embodiments, the composition comprises a strobilurin fungicide.

In some embodiments, viscosity of the composition between 700-2000 cP measured with a Brookfield spindle 63 at 12 rpm. In some embodiments, the viscosity of the composition is 1000-1500 (spindle 62 @ 12 rpm). In some embodiments, the viscosity of the composition is 800-1500 (spindle 62 @ 12 rpm). In some embodiments, the viscosity of the composition between 700-2000 cP measured with Brookfield spindle 62 at 12 RPM.

In some embodiments, the composition has a pH between 5-8.

In some embodiments, the composition comprising the polycation and the dithiocarbamate fungicide has neutral zeta potential, wherein neutral zeta potential refers to 0 mv±5 mv.

In some embodiments, the polycation and the mancozeb has neutral zeta potential. In some embodiments, neutral zeta potential refers to ±5 my.

In some embodiments, the agriculturally acceptable carrier is an aqueous carrier. In some embodiments, the agriculturally acceptable carrier is a combination of an aqueous carrier and a water immiscible carrier.

i) Suspension Concentrate Compositions

In some embodiments, the composition is a suspension concentrate composition.

In some embodiments, the composition is a suspension concentrate composition and the agriculturally acceptable carrier is an aqueous carrier.

ii) Suspoemulsion Compositions

In some embodiments, the composition is a suspoemulsion composition.

In some embodiments, the composition is a suspoemulsiosn composition and the agriculturally acceptable carrier is a combination of an aqueous carrier and an organic phase.

In some embodiments, the composition is a suspoemulsiosn composition and the agriculturally acceptable carrier is a combination of an aqueous carrier and a water immiscible carrier.

In some embodiments, the suspoemulsion composition comprises at least one emulsifier.

In some embodiments, the emulsifier has a HLB between 8.5 to 11.5. In some embodiments, the emulsifier has a HLB between 8.5 to 11, more preferred a HLB of 10.

In some embodiments, the emulsifier is a nonionic surfactants or mixture of surfactants selected from the group consisting of alcohol ethoxylates, alcohol ethoxylate propoxylate, sulfated alcohol ethoxylate, alcohol ethoxylate phosphate ester, fatty acid ethoxylate, mono glyceride ethoxylate, di glyceride ethoxylate, triglyceride ethoxylate, castor oil ethoxylates, allkylaryl ethoxylate, aryl ethoxylate, alkyaryl alcohol ethoxylates, aryl alcohol ethoxylate, alkyl phenol ethoxylate, aryl phenol ethoxylate, styrenated phenol ethoxylates, sorbitan esters, ethoxylated sorbitan esters, alkyl polyglucosides, glucamides, and any combination thereof.

In some embodiments, the emulsifier is tristyrylphenol ethoxylate with 10 EO (Emulsogen TS 100).

In some embodiments, a water immiscible carrier may include but not limited to high aromatic solvents such as Solvesso 150, Solvesso 150ND, Solvesso 200, Solvesso 200ND, and any combination thereof.

In some embodiments, the suspoemulsion composition further comprising at least one co-solvent.

Co-solvents may include, but are not limited to, alkylamide of C8/C10, C10, C12 fatty acids, dimethylamide of C8/C10, C10, C12 fatty acid, mixture of dibasic esters of succinic acid, glutaric acid, adipic acid, dimethyl succinate, dimethyl glutarate, dimethyladipate mixture, Rhodiasolv RPDE, Rhodasolv Match 111, monobasic ester, ethylhexyl lactate, benzyl acetate, and any combination thereof.

In some embodiments, the amount of the water immiscible carrier in the composition is between 2-15% by weight based on the total weight of the composition.

In some embodiments, the amount of the co-solvent in the composition is between 1-5% by weight based on the total weight of the composition.

In some embodiments, the amount of the emulsifier in the composition is between 0.1-2% by weight based on the total weight of the composition.

In some embodiments of the suspoemulsion composition, the azole fungicide is dissolved in the oil phase and the dithiocarbamate is suspended in the aqueous phase. In some embodiments, the oil phase is an organic solvent phase.

In some embodiments, the dithiocarbamate fungicide is suspended in the aqueous carrier and the triazole fungicide is dissolved in the water immiscible carrier and/or suspended in the aqueous carrier. In some embodiments, the azole fungicide and/or the additional fungicide(s) are suspended or dissolved in the water immiscible carrier. In some embodiments, the azole fungicide and/or the additional fungicide(s) are suspended or dissolved in the aqueous carrier. In some embodiment, the composition further comprising additional fungicide which is dissolved in the water immiscible carrier and/or suspended in the aqueous carrier. In some embodiments the additional fungicide can be formulated as capsules.

In some embodiments, the composition further comprising second carrier which is an organic solvent.

In some embodiments, the dithiocarbamate fungicide is suspended in the aqueous carrier and the triazole fungicide is dissolved in the organic phase and/or suspended in the aqueous carrier.

In some embodiment, the composition further comprising additional fungicide which is dissolved in the organic phase and/or suspended in the aqueous carrier.

In some embodiments, the organic phase includes the azole fungicide and/or the additional fungicide(s).

In some embodiments, further to the mancozeb, the aqueous carrier includes the azole fungicide and/or the additional fungicide(s).

In some embodiments the additional fungicide can be formulated as capsules.

iii) Agriculturally Acceptable Additives

In some embodiments, the composition further comprises at least one agriculturally acceptable additive.

The addition of an additive affects the chemically and physically stability of the compositions. Said additives may, for example, improve the stability of the composition. The addition of small amounts of one or more agriculturally acceptable additives may affect parameters such as stability, efficacy and/or rainfastness of a composition according to the invention. The addition of small amounts of one or more agriculturally acceptable carriers preferably increases stability, efficacy and/or rainfastness of a composition according to the invention.

In some embodiments, the agriculturally acceptable additive is selected from stabilizers, dispersants, solubilizing agents, buffers, acidifiers, defoaming agents, thickeners, drift retardants, surfactant, pigments, wetting agents, safeners, preservatives such as bacteriostats or bactericides, surfactants, antifoams, solvents, co-solvent, oils, light stabilizers, UV absorbers, radical scavengers and antioxidants, adhesives, neutralizers, thickeners, binders, sequestrates, biocides, anti-freeze agents, and any combination thereof. In some embodiments, the agriculturally acceptable additive is selected from the group consisting of dispersants, lignin-based polymers, sulfur-based polymers, and any combination thereof.

In some embodiments, the composition comprises at least one solvent.

In some embodiments, the amount of the solvent is 0.01% to 5% by weight based on the total weight of the composition.

In some embodiments, the composition further comprising oil.

In some embodiments, the amount of the oil is 0.01% to 5% by weight based on the total weight of the composition.

In some embodiments, the oil is vegetable oil, crop oil and ester thereof. In some embodiments, the oil is methyl ester of soybean oil.

In some embodiments, the composition comprises at least one solubilizing agent.

In some embodiments, the amount of the solubilizing agent is 0.01% to 1% by weight based on the total weight of the composition. In some embodiments, the amount of the solubilizing agent is 0.1% to 1% by weight based on the total weight of the composition. In some embodiments, the amount of the solubilizing agent is 0.1% to 0.5% by weight based on the total weight of the composition. In some embodiments, the amount of the solubilizing agent is about 0.1%, 0.2%, 0.3%, 0.4% or 0.5% by weight based on the total weight of the composition.

In some embodiments, the solubilizing agent is an acid. Acid may be used to obtain solubilized polycation.

In some embodiments, the acid has a pKa lower than 5.

In some embodiments, the acid is a C1-C6 carboxylic acid. The acid may be, but is not limited to, acetic acid, lactic acid or citric acid. In some embodiments, the acid is selected from the group consisting of acetic acid, lactic acid, citric acid and any combination thereof. In some embodiments, the acid is acetic acid.

In some embodiments, the composition comprises a stabilizer.

Acids may be used as stabilizers. Acids are used to obtain dissolution of some polycations. For example, chitosan is an aminoglycan consisting of beta-(1right4)-linked D-glucosamine residues. In acidic environment, global protonation of the 2-amino groups creates cationic chitosan.

In some embodiments, the concentration of the acid in the composition is 0-5% by weight based on the total weight of the composition. In some embodiments, the concentration of the acid in the composition is 0.01-5% by weight based on the total weight of the composition. In some embodiments, the concentration of the acid in the composition is 0.1-0.5% by weight based on the total weight of the composition. In some embodiments, the concentration of the acid in the composition is about 0.1% by weight based on the total weight of the composition. In some embodiments, the concentration of the acid in the composition is about 0.2% by weight based on the total weight of the composition. In some embodiments, the concentration of the acid in the composition is about 0.3% by weight based on the total weight of the composition. In some embodiments, the concentration of the acid in the composition is about 0.4% by weight based on the total weight of the composition. In some embodiments, the concentration of the acid in the composition is about 0.5% by weight based on the total weight of the composition. In some embodiments, the concentration of the acid in the composition is 1-3% by weight based on the total weight of the composition. In some embodiments, the concentration of the acid in the composition is 1.5-2% by weight based on the total weight of the composition.

In some embodiments, the composition comprises at least one dispersant.

In some embodiments, the dispersant is lignosulfonate. In some embodiments, the dispersant has a pH between 4-10.

In some embodiments, the dispersant is basic. In some embodiments, the composition is a suspoemulsion and the dispersant is basic. In some embodiments, the basic dispersant has a pH between 8.5 and 12.

In some embodiments, the basic dispersant is a lignosulfonate. In some embodiments, the basic dispersant is Reax 88B.

In some embodiments, the dispersant is acidic. In some embodiments, the composition is a suspension concentrate and the dispersant is acidic. In some embodiments, the acidic dispersant has a pH between 4-6.9. In some embodiments, the acidic dispersant has a pH of 4.3 (15% w/v, aqueous, 25° C.).

In some embodiments, the acidic dispersant is a lignosulfonate. In some embodiments, the acidic dispersant is Reax 88A.

In some embodiments, when the composition is a suspension concentrate (SC) the dispersant is an acidic dispersant.

In some embodiments, when the composition is SC the dispersant is Reax 88 A. In some embodiments, when the composition is SC the dispersant is sodium salt of a chemically modified low molecular weight kraft lignin polymer solubilized by five sulfonate groups and with an acidic pH.

In some embodiments, when the composition is a suspo-emulsion (SE) the dispersant is a basic dispersant.

In some embodiments, when the composition is SE the dispersant is Reax 88 B. In some embodiments, when the composition is SE the dispersant is a highly sulfonated, low molecular weight kraft lignin polymer with a basic pH.

In some embodiments, the dispersant is a sulfonate polymer.

In some embodiments, the sulfonate polymer is lignin, sodium lignosulfonate, calcium lignosulfonate or any combination thereof.

In some embodiments, the lignosulfonate has a pH between 8.5 and 12. In some embodiments, the lignosulfonate has a pH of 11 (pH, 15% w/v, aqueous, 25° C.). In some embodiments, the lignosulfonate has a pH between 3 and 5. In some embodiments, the lignosulfonate has a pH 4.3

In some embodiments, the lignosulfonate has a degree of sulfonation of between 2.0 and 3.5.

In some embodiments, the lignosulfonate has a degree of sulfonation of 2.9.

In some embodiments, the lignosulfonate has an average weight average molecular weight between 2000 g/mol and 6500 g/mol. In some embodiments, the lignosulfonate has an average weight average molecular weight of about 3100 g/mol. In some embodiments, the lignosulfonate has an average weight average molecular weight of about 2900 g/mol.

In some embodiments, the amount of the dispersant is between 1-15% by weight based on the total weight of the composition. In some embodiments, the amount of the dispersant is between 4-8% by weight based on the total weight of the composition.

In some embodiments, the amount of the lignosulfonate in the composition is between 1-15% by weight based on the total weight of the composition. In some embodiments, the amount of the lignosulfonate in the composition is between 4-8% by weight based on the total weight of the composition. In some embodiments, the amount of the lignosulfonate in the composition is between 5-6% by weight based on the total weight of the composition. In some embodiments, the amount of the lignosulfonate in the composition is 5.2%, 5.3%, 5.6%, or 6% by weight based on the total weight of the composition.

In some embodiments, the composition comprises lignosulfonate and at least one additional dispersant.

In some embodiments, the additional dispersant is preferably present in an amount of between 0.01 to up to 0.5% (w/v), more preferred 0.2% (w/v). In some embodiments, the amount of the additional dispersant in the composition is between 0.01% to 0.5% w/w based on the total weight of the composition. In some embodiments, the amount of the additional dispersant in the composition is between 0.1% to 0.2% w/w based on the total weight of the composition. In some embodiments, the amount of the additional dispersant in the composition is 0.14% w/w based on the total weight of the composition.

Additional dispersant can be but is not limited to 2-ethyl hexanol EO-PO nonionic surfactant (Oxirane, 2-methyl-, polymer with oxirane, mono(2-ethylhexyl) ether) (Ecosurf EH-3).

In some embodiments, the composition comprises at least one surfactant.

Surfactants may include but are not limited to ionic or non-ionic surface-active agents. Examples of surfactants are alkyl-end-capped ethoxylate glycol, alkyl-end-capped alkyl block alkoxylate glycol, dialkyl sulfosuccinate, phosphated esters, alkyl sulfonates, alkyl aryl sulfonates, tristyrylphenol alkoxylates, natural or synthetic fatty acid alkoxylates, natural or synthetic fatty alcohols alkoxylates, alkoxylated alcohols (such as n-butyl alcohol poly glycol ether), block copolymers (such as ethylene oxide-propylene oxide block copolymers and ethylene oxide-butylene oxide block copolymers) or combinations thereof.

The surfactant can be castor oil ethoxylate, or other nonionic surfactants and mixture of nonionic surfactants having HLB 8.5-11.5 for oil in water emulsion portion of the suspoemulsion.

The surfactant having HLB 8.5-11.5 can be nonionic surfactants including alcohol ethoxylates, alcohol ethoxylate propoxylate, sulfated alcohol ethoxylate, alcohol ethoxylate phosphate ester, fatty acid ethoxylate, mono glyceride ethoxylate, di glyceride ethoxylate, triglyceride ethoxylate, castor oil ethoxylates, alkyarylethoxylates, sorbitan ester, ethoxylated sorbitan ester, alkyl polyglucosides and glucamides.

Examples of surfactants include but is not limited to, additional dispersants (up to 0.5% w/w) and wetting agents.

In some embodiments, the surfactant is a wetting agent. In some embodiments, the surfactant is a non-ionic surfactant. In some embodiments, the surfactant is an ionic surfactant

In some embodiments, the concentration of the wetting agent in the composition is 0-0.5% by weight based on the total weight of the composition. In some embodiments, the concentration of the surfactant in the composition is 0.001-0.5% by weight based on the total weight of the composition. In some embodiments, the concentration of the surfactant in the composition is 0.01-1% by weight based on the total weight of the composition. In some embodiments, the concentration of the surfactant in the composition is about 0.1% by weight based on the total weight of the composition.

In some embodiments, the concentration of the non-ionic hydrocarbon-based surfactant in the composition is 0.001-0.5% by weight based on the total weight of the composition. In some embodiments, the concentration of the non-ionic hydrocarbon-based surfactant in the composition is about 0.1% by weight based on the total weight of the composition. In some embodiments, the concentration of the non-ionic hydrocarbon-based surfactant in the composition is 0.001-0.1% by weight based on the total weight of the composition.

In some embodiments, the concentration of the surfactant in the composition is 2-5% w/w by weight based on the total weight of the total composition.

In some embodiments, the concentration of the surfactant in the composition is 0.1-5% w/w based on the total weight of the total composition, preferably 1 to 3% w/w based on the total weight of the composition.

In some embodiments, the composition is a suspension concentrate and the concentration of the surfactant in the composition is 0.01-3% w/w based on the total weight of the composition. In some embodiments, the composition is a suspension concentrate and the concentration of the surfactant in the composition is 0.1-1% w/w based on the total weight of the composition. In some embodiments, the composition is a suspension concentrate and the concentration of the surfactant in the composition is 0.1-0.2% w/w based on the total weight of the composition. In some embodiments, the composition is a suspension concentrate and the concentration of the surfactant in the composition is 0.1% w/w or 0.14% w/w based on the total weight of the composition.

In some embodiments, the composition is a suspoemulsion and the concentration of the surfactant in the composition is 1-5% w/w based on the total weight of the composition. In some embodiments, the composition is a suspoemulsion and the concentration of the surfactant in the composition is 2-3% w/w based on the total weight of the composition. In some embodiments, the composition is a suspoemulsion and the concentration of the surfactant in the composition is 2.5% w/w based on the total weight of the composition.

In some embodiments the composition comprises at least one wetting agent.

A wetting agent, when present, is preferably selected from sodium lauryl dulphate (Galaxy 796G, Stepwet DF-95), di-octylsuccinate, polyoxyethylene/polypropylene, hydrocarbon based high wetting surfactant (Triton HW 1000) and tri-stearyl sulphonate/phosphate.

A composition of the invention may also comprise two or more different wetting agents. A wetting agent is present in an amount of between 0 to up to 10% (w/w), more preferred between 0.01 to up to 5% (w/v), more preferred between 0.02 to up to 1% (w/w), more preferred about 0.05% (w/w) to 0.5% (w/w), more preferably, 0.1% (w/w).

In some embodiments, the wetting agent is polyalkylene oxide block copolymer. In some embodiments, the wetting agent is butyl block copolymer. In some embodiments, the butyl block copolymer is Atlas™ G5002L (sold by Croda).

In some embodiments, the concentration of the wetting agent in the composition is 0.01-10% by weight based on the total weight of the composition. In some embodiments, the concentration of the wetting agent in the composition is 0.01-5% by weight based on the total weight of the composition. In some embodiments, the concentration of the wetting agent in the composition is 1-5% by weight based on the total weight of the composition. In some embodiments, the concentration of the wetting agent in the composition is 1-3% by weight based on the total weight of the composition. In some embodiments, the concentration of the wetting agent in the composition is about 2% by weight based on the total weight of the composition. In some embodiments, the concentration of the wetting agent in the composition is about 0.1-0.3% by weight based on the total weight of the composition. In some embodiments, the concentration of the wetting agent in the composition is about 0.1% by weight based on the total weight of the composition. In some embodiments, the concentration of the wetting agent in the composition is about 0.2% by weight based on the total weight of the composition.

In some embodiments, the composition comprises at least one pH adjuster or buffering agent such as organic or inorganic bases and/or organic or inorganic acids.

In some embodiments, the composition comprises at least one anti-foam agent.

In some embodiments, the anti-foam agent is silicone-based. An anti-foam agent, when present, is preferably selected from polymethylsiloxane, polydimethylsiloxane, simethicone octanol, and silicone oils. A composition of the invention may also comprise two or more different anti-foam agents. In some embodiments, the anti-foaming agent is a polydimethylsiloxane anti-foaming agent.

An anti-foam agent is preferably present in an amount of between 0 to up to 10% (w/v), more preferred between 0.05 to up to 5% (w/v), more preferred between 0.1 to up to 1% (w/v), more preferred about 0.05% (w/v).

In some embodiments, the concentration of the anti-foam forming agent is 0.01-5% by weight based on the total weight of the composition. In some embodiments, the concentration of the anti-foam forming agent is 0.1-1% by weight based on the total weight of the composition. In some embodiments, the concentration of the anti-foam forming agent is 0.3-0.5% by weight based on the total weight of the composition. In some embodiments, the concentration of the anti-foam forming agent is about 0.4% by weight based on the total weight of the composition. In some embodiments, the concentration of the anti-foam forming agent is about 0.5% by weight based on the total weight of the composition. In some embodiments, the concentration of the anti-foam forming agent is 0.39%, 0.4% or 0.45% by weight based on the total weight of the composition.

In some embodiments, the composition comprises at least one antifreezing agent.

An antifreezing agent, when present, is preferably selected from glycerine, ethylene glycol, hexyleneglycol and propylene glycol. A composition of the invention may also comprise two or more different antifreezing agents. In some embodiments, the antifreezing agent is propylene glycol.

An antifreezing agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the concentration of the antifreezing agent in the composition is 1-10% by weight based on the total weight of the composition. In some embodiments, the concentration of the antifreezing agent in the composition is 1-5% by weight based on the total weight of the composition. In some embodiments, the concentration of the antifreezing agent in the composition is about 3% by weight based on the total weight of the composition. In some embodiments, the concentration of the antifreezing agent in the composition is about 4% by weight based on the total weight of the composition. In some embodiments, the concentration of the antifreezing agent in the composition is about 5% by weight based on the total weight of the composition. In some embodiments, the concentration of the antifreezing agent in the composition is 3.3%, 3.7%, or 4% by weight based on the total weight of the composition.

In some embodiments, the composition comprises at least one rheology modifier. In some embodiments, the agriculturally acceptable additive is a rheology modifier.

In some embodiments, the rheology modifier is a thickener. In some embodiments, the composition comprises at least one thickener.

A thickening agent, when present, is preferably selected from agar, alginic acid, alginate, carrageenan, gellan gum, xanthan gum, succinoglycan gum, guar gum, acetylated distarch adipate, acetylated oxidized starch, arabinogalactan, ethyl cellulose, methyl cellulose, locust bean gum, starch sodium octenylsuccinate, and triethyl citrate. A composition of the invention may also comprise two or more different thickening agents.

In some embodiments, the thickener is xanthan gum. In some embodiments, the rheology modifier is Rhodopol® 23 (sold by Solvay). In some embodiments, the rheology modifier is xanthan gum.

A thickening agent is preferably present in an amount of between 0 to up to 10% (w/v), more preferred between 0.01 to up to 5% (w/v), more preferred between 0.02 to up to 1% (w/v), more preferred about 0.05% (w/v).

In some embodiments, the concentration of the rheology modifier in the composition is 0.01-10% by weight based on the total weight of the composition. In some embodiments, the concentration of the rheology modifier in the composition is 1-6% by weight based on the total weight of the composition. In some embodiments, the concentration of the rheology modifier in the composition is 1-5% by weight based on the total weight of the composition. In some embodiments, the concentration of the rheology modifier in the composition is about 1% by weight based on the total weight of the composition. In some embodiments, the concentration of the rheology modifier in the composition is about 1.7% by weight based on the total weight of the composition. In some embodiments, the concentration of the rheology modifier in the composition is about 2.5% by weight based on the total weight of the composition. In some embodiments, the concentration of the rheology modifier in the composition is about 5% by weight based on the total weight of the composition. In some embodiments, the concentration of the rheology modifier in the composition is about 2.3% by weight based on the total weight of the composition. In some embodiments, the concentration of the rheology modifier in the composition is about 3% by weight based on the total weight of the composition.

In some embodiments, the composition comprises at least one thickener and at least one biocide. In some embodiments, the amount of the thickener and the biocide in the composition is up to 1% by weight based on the total weight of the composition.

In some embodiments, the agriculturally acceptable additive is a preservative. In some embodiments, the composition comprises at least one preservative.

In some embodiments, the preservative is a biocide. In some embodiments, the composition comprises at least one biocide.

In some embodiments, the concentration of the preservative in the composition is 0.01-5% by weight based on the total weight of the composition. In some embodiments, the concentration of the preservative in the composition is 0.01-1% by weight based on the total weight of the composition. In some embodiments, the concentration of the preservative in the composition is about 0.1% by weight based on the total weight of the composition. In some embodiments, the concentration of the preservative in the composition is about 0.06% by weight based on the total weight of the composition. In some embodiments, the concentration of the preservative in the composition is about 0.07% by weight based on the total weight of the composition. In some embodiments, the concentration of the preservative in the composition is about 0.08% by weight based on the total weight of the composition.

In some embodiments, the composition comprises at least one additional bioactive ingredient, preferably an additional insecticide, fungicide and/or herbicide.

In some embodiments, the composition is substantially free of an agriculturally acceptable organic solvent. In some embodiments, the composition is aqueous.

The present invention provides a suspension concentrate composition comprising:
a. 35.4% w/w of mancozeb,
b. 3% w/w of prothioconazole,
c. 2.3% w/w of picoxystrobin,
d. 0.5% w/w of chitosan,
e. 0.14% w/w 2-ethyl hexanol EO-PO nonionic surfactant,
f. 5% w/w of sodium lignosulfonate,
g. 0.23% w/w of acetic acid,
h. 0.4% w/w of polydimethylsiloxane anti-foaming emulsion,
i. 3.7% w/w of propylene glycol,
j. 0.07% w/w of biocide,
k. 2% w/w of methyl soyate,
l. 0.15% w/w of sodium isopropyl naphthalene sulfonate,
m. 2.5% w/w of xanthan gum, and
n. 44% w/w of water.

The present invention provides a suspension concentrate composition comprising:
a. 35.8% w/w of mancozeb,
b. 2.6% w/w of tebuconazole,
c. 2% w/w of picoxystrobin,
d. 0.4% w/w of chitosan,
e. 0.1% w/w nonionic hydrocarbon surfactant,
f. 5.6% w/w of sodium lignosulfonate,
g. 0.2% w/w of acetic acid,
h. 0.39% w/w of polydimethylsiloxane anti-foaming emulsion,
i. 3.3% w/w of propylene glycol,
j. 0.06% w/w of biocide,
k. 1.6% w/w of methyl soyate,
l. 0.1% w/w of sodium lauryl sulphate,
m. 1.7% w/w of xanthan gum, and
n. 46.3% w/w of water.

The present invention provides a suspension concentrate composition comprising:
a. 36% w/w of mancozeb,
b. 2.5% w/w of prothioconazole,
c. 0.5% w/w of chitosan,
d. 0.14% w/w nonionic hydrocarbon surfactant,
e. 5.2% w/w of sodium lignosulfonate,
f. 0.23% w/w of acetic acid,
g. 0.45% w/w of polydimethylsiloxane anti-foaming emulsion,
h. 3.7% w/w of propylene glycol,
i. 0.07% w/w of biocide,
j. 2.0% w/w of methyl soyate,
k. 0.14% w/w of sodium isopropyl naphthalene sulfonate,
l. 2.5% w/w of xanthan gum, and
m. 46.6% w/w of water.

In some embodiments, the suspo-emulsion composition comprises:
a. 37% w/w of mancozeb,
b. 3% w/w of prothioconazole,
c. 2.3% w/w of picoxystrobin,
d. 0.5% w/w of chitosan,
e. 0.3% w/w of acetic acid,
f. 4% w/w of propylene glycol,
g. 6% w/w of sodium lignosulphonate,
h. 0.08% w/w of biocide,
i. 1% w/w of xanthan gum,
j. 0.5% w/w of tristyryl phenol ethoxylate,
k. 9% w/w of naphthalene,
l. 2.5% w/w of a di-ester blend,
m. 0.4% w/w of polydimethylsiloxane anti-foaming emulsion, and
n. 33.5% w/w of water.

In some embodiments, the suspo-emulsion composition comprises:
a. 35.9% w/w of mancozeb,
b. 2.5% w/w of prothioconazole,
c. 0.5% w/w of chitosan,
d. 0.3% w/w of acetic acid,
e. 4% w/w of propylene glycol,
f. 6% w/w of sodium lignosulphonate (reax 88B),
g. 0.1% w/w of biocide,
h. 2.5% w/w of Ag/RH23 2% solution,
i. 0.5% w/w of tristyryl phenol ethoxylate (TSP-10),
j. 9% w/w of solvesso 200,
k. 2.5% w/w of Rhodiasolv Match 111,
l. 0.4% w/w of polydimethylsiloxane anti-foaming emulsion, and
m. 2.6+33.2% w/w, or balance, of water

In some embodiments, the suspo-emulsion composition comprises:
a. 35.9% w/w of mancozeb,
b. 2.6% w/w of tebuconazole
c. 2.1% w/w of picoxystrobin,
d. 0.5% w/w of chitosan,
e. 0.3% w/w of acetic acid,
f. 4% w/w of propylene glycol,
g. 6% w/w of sodium lignosulphonate (reax 88B),
h. 0.1% w/w of biocide,
i. 2.5% w/w of Ag/RH23 2% solution
j. 0.5% w/w of tristyryl phenol ethoxylate, (TSP-10)
k. 9% w/w of solvesso 200,
l. 2.5% w/w of Rhodiasolv Match 111,
m. 0.4% w/w of polydimethylsiloxane anti-foaming emulsion, and
n. 33.7% w/w, or balance, of water

The invention also provides a delivery system comprising any one of any combinations or compositions described herein.

A composition according to the invention may comprise an additional bioactive ingredient, also termed additional agrochemical, such as a growth regulator, a bio-stimulant, a fungicide, a herbicide, an insecticide, an acaricide, a molluscicide, a miticide, a rodenticide; and/or an bactericide.

In some embodiments, the, composition is tank mixed with an additional agrochemical. In some embodiments, composition is applied sequentially with the additional agrochemical. In some embodiments, composition is applied simultaneously with the additional agrochemical.

Additional agrochemicals that may be used with the macromolecular complex, composition or delivery system of the present invention are described below.

Various agrochemicals may be used as additional bioactive ingredient. Exemplary among such agrochemicals without limitation are crop protection agents, for example pesticides, safeners, plant growth regulators, repellents, bio-stimulants and preservatives such as bacteriostats or bactericides.

A composition of the invention may also comprise two or more additional bioactive ingredients, such as two or more fungicides, two or more herbicides, two or more insecticides, two or more acaricides, two or more bactericides, or combinations thereof, such as at least one antifungal compound and at least one insecticide, at least one antifungal compound and at least one herbicide, at least one antifungal compound and at least one acaricide, at least one antifungal compound and at least one bactericide, at least one herbicide and at least one insecticide, at least one herbicide and at least one acaricide, at least one herbicide and at least one bactericide, at least one insecticide and at least one acaricide, at least one insecticide and at least one bactericide, and at least one acaricide and at least one bactericide. Some bioactive ingredients have a wide range of target organisms, as is known to the skilled person, and are therefore included in more than one subgroup of bioactive ingredients. Said at least one additional bioactive ingredient preferably is present in a concentration of between 0.1 and 30 w/w %.

Said additional bioactive ingredient preferably is an insecticide, a fungicide and/or an herbicide.

A preferred additional insecticide is a carbamate such as carbofuran, propoxur, methomyl, bendiocarb, formetanate, oxamyl, and aldicarb, an organochlorine such as methoxychlor, kelthane, lindane, toxaphene, and cyclodiene insecticides such as aldrin, dieldrin, endrin, mirex, chlordane, heptachlor, and endosulfan, an organophosphate such as parathion, malathion, methyl parathion, chlorpyrifos, diazinon, dichlorvos, phosmet, fenitrothion, tetrachlorvinphos, azamethiphos, azinphos-methyl, and terbufos, a formamidine such as amitraz, chlordimeform, formetanate, formparanate, medimeform, and semiamitraz, an organosulfur such as dipymetitrone, an avermectin such as ivermectin, doramectin, selamectin, milbemycin oxime and moxidectin, a neonicotinoid such as acetamiprid, clothianidine, imidacloprid, nitenpyram, nithiazine, thiacloprid and thiamethoxam and/or a pyrethroid insecticide such as allethrin, bifenthrin, cyfluthrin, cypermethrin, cyphenothrin, deltamethrin, esfenvalerate, etofenprox, fenpropathrin, fenvalerate, flucythrinate, flumethrin, fmiprothrin, lambda-cyhalothrin, metofluthrin, permethrin, resmethrin, silafluofen, sumithrin, tau-fluvalinate, tefluthrin, tetramethrin, tralomethrin, and transfluthrin.

A preferred additional fungicide is selected from sodium ortho-phenylphenate, 2-phenylphenol; 8-hydroxyquinoline sulphate; acibenzolar-5-methyl; actinovate; aldimorph; amidoflumet; ampropylfos; ampropylfos-potassium; andoprim; anilazine; azoxystrobin; benalaxyl; benodanil; benomyl (methyl 1-(butylcarbamoyl)benzimidazol-2-ylcarbamate); benthiavalicarb-isopropyl; benzamacril; benzamacril-isobutyl; bilanafos; binapacryl; biphenyl; blasticidin-S; boscalid; bupirimate; buthiobate; butylamine; calcium polysulphide; capsimycin; captafol; captan (N-(trichloromethylthio)cyclohex-4-ene-1,2-dicarboximide); carbendazim; carboxin; carpropamid; carvone; chinomethionat; chlobenthiazone; chlorfenazole; chloroneb; chlorothalonil; chlozolinate; cis-1-(4-chlorophenyl)-2-(1H-1,2,4-triazol-1-yl)-cycloheptanol; clozylacon; a conazole fungicide such as, for example, (RS)-1-(β-allyloxy-2,4-dichlorophenethyl)imidazole (imazalil; Janssen Pharmaceutica NV, Belgium) and N-propyl-N-[2-(2,4,6-trichlorophenoxy)ethyl]imidazole-1-carboxamide (prochloraz); cyazofamid; cyflufenamid; cymoxanil; cyprodinil; cyprofuram; Dagger G; debacarb; dichlofluanid; dichlone; dichlorophen; diclocymet; diclomezine; dicloran; diethofencarb; diflumetorim; dimethirimol; dimethomorph; dimoxystrobin; dinocap; diphenylamine; dipyrithione; ditalimfos; dithianon; dodine; drazoxolon; edifenphos; ethaboxam; ethirimol; etridiazole; famoxadone; fenamidone; fenapanil; fenfuram; fenhexamid; fenitropan; fenoxanil; fenpiclonil; fenpropidin; fenpropimorph; fluazinam (3-chloro-N-(3-chloro-5-trifluoromethyl-2-pyridyl)-α,α,α-trifluoro-2,6-dinitro-p-toluidine); flubenzimine; fludioxonil; flumetover; flumorph; fluoromide; fluoxastrobin; flurprimidol; flusulfamide; flutolanil; folpet (N-(trichloromethylthio)phthalimide); fosetyl-A1; fosetyl-sodium; fuberidazole; furalaxyl; furametpyr; furcarbanil; furmecyclox; guazatine; hexachlorobenzene; hymexazol; iminoctadine triacetate; iminoctadine tris(albesilate); iodocarb; iprobenfos; iprodione; iprovalicarb; irumamycin; isoprothiolane; isovaledione; kasugamycin; kresoxim-methyl; mandipropamid, meferimzone; mepanipyrim; mepronil; metalaxyl; metalaxyl-M; methasulfocarb; methfiroxam; methyl 1-(2,3-dihydro-2,2-dimethyl-1H-inden-1-yl)-1H-imidazole-5-carboxylate; methyl 2-[[[cyclopropyl[(4-methoxyphenyl)imino]methyl]thiol-methyl]alph-a.-(methoxymethylene)benzeneacetate; methyl 2-[2-[3-(4-chlorophenyl)-1-methyl-allylideneaminooxymethyl]phenyl]-3-meth-oxy acrylate; metiram; metominostrobin; metrafenone; metsulfovax; mildiomycin; monopotassium carbonate; myclozolin; N-(3-ethyl-3,5,5-trimethylcyclohexyl)-3-formyl amino-2-hydroxybenzamide; N-(6-methoxy-3-pyridinyl)cyclopropanecarboxamide; a polyene fungicide such as natamcyin; N-butyl-8-(1,1-dimethyl ethyl)-1-oxaspiro[4.5]decan-3-amine; nitrothal-isopropyl; noviflumuron; ofurace; orysastrobin; oxadixyl; oxolinic acid; oxycarboxin; oxyfenthiin; pencycuron; penthiopyrad; phosdiphen; phosphite salts such as disodium phosphite and potassium phosphite, phthalide; picobenzamid; picoxystrobin; piperalin; polyoxins; polyoxorim; procymidone; propamocarb; propanosine-sodium; propineb; proquinazid; pyraclostrobin; pyrazophos; pyrimethanil; pyroquilon; pyroxyfur; pyrrolnitrine, quinconazole; quinoxyfen; quintozene; silthiofam; sodium tetrathiocarbonate; spiroxamine; sulphur; tecloftalam; tecnazene; tetcyclacis; thiazole fungicide such as, for example, 2-(thiazol-4-yl)benzimidazole (thiabendazole), thicyofen; thifluzamide; thiophanate-methyl; tiadinil; tioxymid; tolclofos-methyl; tolylfluanid; triazbutil; triazoxide; tricyclamide; tricyclazole; tridemorph; trifloxystrobin; validamycin A; vinclozolin; zoxamide; (2S)— N-[2-[4-[[3-(4-chlorophenyl)-2-propynyl]oxy]-3-methoxy phenyl]ethyl]-3-met-hyl-2-[(methylsulphonyl)amino]butanamide; 1-(1-naphthalenyl)-1H-pyrrole-2,5-dione; 2,3,5,6-tetrachloro-4-(methylsulphonyl)pyri dine; 2,4-dihydro-5-methoxy-2-methyl-4-[[[[1-[3-(trifluoromethyl)phenyl]-ethyli-dene]amino]oxy]methyl]phenyl]-3H-1,2,3-triazol-3-one; 2-amino-4-methyl-N-phenyl-5-thiazolecarboxamide; 2-chloro-N-(2,3-dihydro-1,1,3-trimethyl-1H-inden-4-yl)-3-pyridinecarboxam-ide; 3,4,5-trichloro-2,6-pyridinedicarbonitrile; 3-[(3-bromo-6-fluoro-2-methyl-1H-indol-1-yl)sulphonyl]-N,N-dimethyl-1H-1,-2,4-triazole-1-sulphonamide, and/or mixtures thereof.

A most preferred additional fungicide is natamycin. A composition of the invention may also comprise two or more additional fungicides, such as, for example, natamycin and a strobilurin type of fungicides such as azoxystrobin, natamycin and a triazole type of fungicides such as cyproconazole, natamycin and a succinate dehydrogenase inhibitor type of fungicides such as boscalid, natamycin and a pthalimide/pthalonitrile type of fungicide such as chlorothalonil, natamycin and captan, natamycin and a benzimidazole type of fungicide such as thiabendazole, natamycin and a carbamate type of fungicides such as propamocarb, natamycin and a carboxamide type of fungicides such as fenoxanil, natamycin and a dicarboxamide type of fungicide such as iprodione, natamycin and a morpholine type of fungicide such as dimethamorph, natamycin and an organophosphate type of fungicide such as fosetyl, natamycin and an azole type of fungicide such as prothioconazole, natamycin and a phenylamide type of fungicide such as metalaxyl, natamycin and a fungicide not belonging to a specific group of fungicides such as fludioxynil and/or folpet.

In some embodiments, the composition of the present invention is combined with fenpropidin. In some embodiments, the composition of the present invention is combined with difenoconazole. In some embodiments, the composition of the present invention is combined with tebuconazole. In some embodiments, the composition of the present invention is combined with prothioconazole. In some embodiments, the composition of the present invention is combined with prothioconazole and fluxapyroxad. In some embodiments, the composition of the present invention is combined with tebuconazole and fluxapyroxad. In some embodiments, the composition of the present invention is combined with difenoconazole and fluxapyroxad. In some embodiments, the composition of the present invention is combined with prothioconazole and picoxystrobin. In some embodiments, the composition of the present invention is combined with tebuconazole and picoxystrobin. In some embodiments, the composition of the present invention is combined with difenoconazole and picoxystrobin. In some embodiments, the composition of the present invention is combined with fenpropidin and picoxystrobin. In some embodiments, the composition of the present invention is combined with fenpropidin and fluxapyroxad. In some embodiments, the composition of the present invention is combined with prothioconazole and trifloxystrobin. In some embodiments, the composition of the present invention is combined with cyproconazole and azoxystrobin. In some embodiments, the composition of the present invention is combined with cyproconazole and picoxystrobin. In some embodiments, the composition of the present invention is combined with picoxystrobin and tebuconazole.

A preferred additional herbicide is selected from an inhibitor of amino acid synthesis such as inhibitors of 5-enolpyruvyl-shikimate-3-phosphate synthase, acetolactate synthase and glutamine synthetase such as a glyphosate, a sulfonylurea, an imidazolinone, a glufosinate and/or a 1,2,4-triazol[1,5A]pyrimidine; a photosynthetic inhibitor that binds D-1:quinone-binding protein, including anilides, benzimidazoles, biscarbamates, pyridazinones, triazinediones, triazines, triazinones, uracils, substituted ureas, quinones, hydroxybenzonitriles, and several unclassified heterocycles; inhibitors of acetyl-CoA carboxylase such as aryloxyphenoxy alkanoic acids and cyclohexanediones; inhibitors of cellular division such as phosphoric amide and dinitroaniline; inhibitors of the terpenoid synthesis pathway such as substituted pyridazinones, m-phenoxybenzamides, fluridone, difunone, 4-hydroxypyridine, aminotriazole amitrole, 6-methyl pyrimidine, isoxazolidinone; inhibitors of dihydropteroate synthase such as asulam, and/or mixtures thereof.

Such preferred additional herbicide is preferably selected from benzobicyclon, mesotrione, sulcotrione, tefuryltrione, tembotrione, 2,4-dichlorophenoxyacetic acid, 3,6-dichloro-2-methoxybenzoic acid (dicamba), 4-hydroxy-3-[[2-(2-methoxyethoxy)methyl]-6-(trifluoromethyl)-3-pyridinyl]carbonyl]-bicyclo[3.2.1]-oct-3-en-2-one (bicyclopyrone), ketospiradox or the free acid thereof, benzofenap, pyrasulfotole, pyrazolynate, pyrazoxyfen, topramezone, [2-chloro-3-(2-methoxy ethoxy)-4-(methylsulfonyl)phenyl](1-ethyl-5-hydroxy-1H-pyrazol-4-yl)-methanone, (2,3-dihydro-3,3,4-tri methyl-1,1-dioxidobenzo[b]thien-5-yl)(5-hydroxy-1-methyl-1H-pyrazol-4-yl)-methanone, isoxachlortole, isoxaflutole, a-(cyclopropylcarbonyl)-2-(methylsulfonyl)-oxo-4-chloro-benzenepropanenitrile, and a-(cyclopropylcarbonyl)-2-(methylsulfonyl)-oxo-4-(trifluoromethyl)-benzenepropanenitrile.

Preferred combinations with a macromolecular complex comprising a polyelectrolyte and a dithiocarbamate such as zinc; manganese(2+); N-[2-(sulfidocarbothioylamino)ethyl]carbamodithioate are dimethomorph, cymoxanil, carbendazim, imidacloprid, zoxamide and metalaxyl.

Preferred additional pesticides may be combined with a macromolecular complex comprising a poly electrolyte and a dithiocarbamate such as zinc; manganese(2+); N-[2-(sulfidocarbothioylamino)ethyl]carbamodithioate are one or more of dimethomorph, cymoxanil, carbendazim, imidacloprid, zoxamide and metalaxyl.

The present invention provides a composition comprising a polyelectrolyte and a dithiocarbamate fungicide, wherein the agglomeration rate is decreased compared to composition comprising a dithiocarbamate fungicide in the absence of the polyelectrolyte.

The present invention provides a composition comprising (1) a polycation, (2) a dithiocarbamate fungicide, (3) an azole fungicide and (4) optionally, at least one additional fungicide.

The present invention provides a composition comprising (1) a macromolecular complex of a polyelectrolyte and a dithiocarbamate fungicide, (2) an azole fungicide, and (3) optionally, at least one additional fungicide.

The present invention provides a composition comprising (1) a dithiocarbamate fungicide, (2) an azole fungicide and (3) an aqueous carrier.

The present invention provides a composition comprising (1) a polycation, (2) a dithiocarbamate fungicide, (3) an azole fungicide, and (4) an aqueous carrier.

The present invention provides a composition comprising (1) a polycation, (2) a dithiocarbamate fungicide, (3) at least one additional agrochemical, and (4) an aqueous carrier.

The present invention provides a composition comprising (1) a macromolecular complex of a polyelectrolyte and a dithiocarbamate fungicide, (2) an azole fungicide, and (3) an aqueous carrier, wherein (i) the polyelectrolyte is a polycation, and (ii) the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the dithiocarbamate fungicide.

The present invention provides a concentrate composition comprising (1) a macromolecular complex comprising (i) a dithiocarbamate fungicide and (ii) a polycation, (2) an azole fungicide and (3) an aqueous carrier.

The present invention also provides a suspension concentrate composition comprising (1) a macromolecular complex comprising (i) a dithiocarbamate fungicide and (ii) a polycation, (2) an azole fungicide and (3) an aqueous carrier.

The present invention also provides a suspoemulsion composition comprising (1) a macromolecular complex comprising (i) a dithiocarbamate fungicide and (ii) a polycation, (2) an azole fungicide, (3) an aqueous carrier, and (4) a water immiscible carrier.

The present invention provides a fungicidal composition comprising: (1) at least one dithiocarbamate fungicide, (2) polycation, (3) at least one triazole fungicide (4) optionally, at least one additional fungicide and (5) an aqueous carrier, wherein (i) the dithiocarbamate fungicide is suspended in the aqueous carrier and (ii) the triazole fungicide and the optional additional fungicide are dissolved in the water immiscible carrier and/or suspended in the aqueous carrier.

The present invention provides a composition comprising (1) a polycation, (2) a dithiocarbamate fungicide, and (3) optionally, at least one fungicide.

The present invention provides a composition comprising (1) a macromolecular complex of a polyelectrolyte and a dithiocarbamate fungicide, and (2) optionally, at least one fungicide.

The present invention provides a composition comprising (1) a dithiocarbamate fungicide, (2) an azole fungicide and (3) an aqueous carrier.

The present invention provides a composition comprising (1) a polycation, (2) a dithiocarbamate fungicide, (2) an azole fungicide and (4) optionally, at least one additional fungicide.

The present invention provides a composition comprising (1) a macromolecular complex of a polyelectrolyte and a dithiocarbamate fungicide, (2) an azole fungicide and (4) optionally, at least one additional fungicide.

The present invention provides a composition comprising (1) a dithiocarbamate fungicide, (2) an azole fungicide and (3) an aqueous carrier.

The present invention provides a composition comprising (1) a polycation, (2) a dithiocarbamate fungicide, (3) an azole fungicide, and (4) an aqueous carrier.

The present invention provides a composition comprising (1) a polycation, (2) a dithiocarbamate fungicide, (3) at least one additional agrochemical, and (4) an aqueous carrier.

The present invention provides a composition comprising (1) a macromolecular complex of a polyelectrolyte and a dithiocarbamate fungicide, (2) an azole fungicide, and (3) an aqueous carrier, wherein (i) the polyelectrolyte is a polycation, and (ii) the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the dithiocarbamate fungicide.

The present invention provides a concentrate composition comprising (1) a macromolecular complex comprising (i) a dithiocarbamate fungicide and (ii) a polycation, (2) an azole fungicide and (3) an aqueous carrier.

The present invention also provides a suspension concentrate composition comprising (1) a macromolecular complex comprising (i) a dithiocarbamate fungicide and (ii) a polycation, (2) an azole fungicide and (3) an aqueous carrier.

The present invention also provides a suspoemulsion composition comprising (1) a macromolecular complex comprising (i) a dithiocarbamate fungicide and (ii) a polycation, (2) an azole fungicide, (3) an aqueous carrier, and (4) a water immiscible carrier.

The present invention provides a concentrate composition comprising (1) a macromolecular complex comprising (i) a dithiocarbamate fungicide and (ii) a polycation, (2) an azole fungicide (3) additional fungicide and (4) an aqueous carrier.

The present invention also provides a suspension concentrate composition comprising (1) a macromolecular complex comprising (i) a dithiocarbamate fungicide and (ii) a polycation, (2) an azole fungicide (3) additional fungicide and (4) an aqueous carrier.

The present invention also provides a suspoemulsion composition comprising (1) a macromolecular complex comprising (i) a dithiocarbamate fungicide and (ii) a polycation, (2) an azole fungicide, additional fungicide (4) an aqueous carrier, and (5) a water immiscible carrier.

The present invention provides a fungicidal composition comprising: (1) at least one dithiocarbamate fungicide, (2) polycation, (3) at least one triazole fungicide (4) optionally, at least one additional fungicide and (5) an aqueous carrier, wherein (1) the dithiocarbamate fungicide is suspended in the aqueous carrier and (2) the triazole fungicide and the optional additional fungicide are dissolved in the water immiscible carrier and/or suspended in the aqueous carrier.

The present invention provides a composition comprising (1) a macromolecular complex of a polyelectrolyte and a dithiocarbamate fungicide and (2) optionally at least one additional fungicide wherein the viscosity of the composition is between 700-2000 cP measured with a Brookfield spindle 63 at 12 rpm and/or the pH is between 5-8. Viscosity may be measured using a Brookfield viscometer, spindle 2, speed 12 rpm, temperature of sample 20° C.

The present invention provides a composition comprising (1) a polycation, (2) a dithiocarbamate fungicide, (2) an azole fungicide and (4) optionally, at least one additional fungicide.

The present invention provides a composition comprising (1) a macromolecular complex of a polyelectrolyte and a dithiocarbamate fungicide, (2) an azole fungicide and (4) optionally, at least one additional fungicide.

The present invention provides a composition comprising (1) a dithiocarbamate fungicide, (2) an azole fungicide and (3) an aqueous carrier.

The present invention provides a composition comprising (1) a polycation, (2) a dithiocarbamate fungicide, (3) an azole fungicide, and (4) an aqueous carrier.

The present invention provides a composition comprising (1) a polycation, (2) a dithiocarbamate fungicide, (3) at least one additional agrochemical, and (4) an aqueous carrier.

The present invention provides a composition comprising (1) a macromolecular complex of a polyelectrolyte and a dithiocarbamate fungicide, (2) an azole fungicide, and (3) an aqueous carrier, wherein (i) the polyelectrolyte is a polycation, and (ii) the macromolecular complex is characterized by intermolecular, non-covalent interactions, preferably electrostatic interactions such as ionic interactions, hydrogen bonds and van der Waals forces, such as dipole-dipole interactions, between the polyelectrolyte and the dithiocarbamate fungicide.

The present invention provides a concentrate composition comprising (1) a macromolecular complex comprising (i) a dithiocarbamate fungicide and (ii) a polycation, (2) an azole fungicide and (3) an aqueous carrier.

The present invention also provides a suspension concentrate composition comprising (1) a macromolecular complex comprising (i) a dithiocarbamate fungicide and (ii) a polycation, (2) an azole fungicide and (3) an aqueous carrier.

The present invention also provides a suspoemulsion composition comprising (1) a macromolecular complex comprising (i) a dithiocarbamate fungicide and (ii) a polycation, (2) an azole fungicide and (3) an aqueous carrier.

The present invention provides a fungicidal composition comprising: (1) at least one dithiocarbamate fungicide, (2) polycation, (3) at least one triazole fungicide (4) optionally, at least one additional fungicide and (5) an aqueous carrier, wherein (1) the dithiocarbamate fungicide is suspended in the aqueous carrier and (2) the triazole fungicide and the optional additional fungicide are dissolved in the water immiscible carrier and/or suspended in the aqueous carrier.

The present invention provides a concentrated composition comprising (1) a dithiocarbamate fungicide, (2) an azole fungicide, and (3) an aqueous carrier.

The present invention provides a fungicidal composition comprising: (1) a macromolecular complex comprising (i) a dithiocarbamate fungicide and (ii) a polycation, (2) at least one triazole fungicide (4) optionally, at least one additional fungicide and (5) an aqueous carrier, wherein (1) the dithiocarbamate fungicide is suspended in the aqueous carrier and (2) the triazole fungicide and optional the additional fungicide are dissolved in the water immiscible carrier and/or suspended in the aqueous carrier.

The present invention provides a concentrate composition comprising (1) a macromolecular complex comprising (i) a dithiocarbamate fungicide and (ii) a polycation, (2) an azole fungicide, (3) strobilurin fungicide and (4) an aqueous carrier.

The present invention also provides a suspension concentrate composition comprising (1) a macromolecular complex comprising (i) a dithiocarbamate fungicide and (ii) a polycation, (2) an azole fungicide (3) strobilurin fungicide and (4) an aqueous carrier.

The present invention also provides a suspoemulsion composition comprising (1) a macromolecular complex comprising (i) a dithiocarbamate fungicide and (ii) a polycation, (2) an azole fungicide, (3) strobilurin fungicide, (4) an aqueous carrier, and (5) a water immiscible carrier.

### 4.3 Uses

The present invention provides the use of polyelectrolyte for formulating a dithiocarbamate fungicide in presence water and/or azole fungicide.

### 4.4 Processes for Preparing Compositions

The invention provides a process for preparing the composition of the present invention.

The present invention provides a process for preparing a suspension concentrate (SC) composition of the present invention comprising (i) preparing a first suspension concentrate composition comprising the dithiocarbamate fungicide and the polyelectrolyte, and (ii) combining the first suspension concentrate composition from step (i) with the additional fungicide(s) to obtain the SC composition of the present invention.

In some embodiments, the additional fungicide(s) in step (ii) is in the form of a SC composition when combined with the suspension concentrate composition from step (i).

The present invention provides a process for preparing a suspension concentrate (SC) composition of the present invention comprising (i) preparing a first suspension concentrate composition comprising the dithiocarbamate fungicide and the polyelectrolyte, and (ii) combining the first suspension concentrate composition from step (i) with the azole fungicide to obtain the SC composition of the present invention.

In some embodiments, the azole fungicide in step (ii) is in the form of a SC composition when combined with the suspension concentrate composition from step (i).

In some embodiments, the suspension concentrate comprising the azole fungicide is prepared prior to combining it with the first suspension concentrate of step (i). An example of this procedure is shown in Examples 1 and 3.

The present invention provides a process for preparing a suspension concentrate (SC) composition of the present invention comprising (i) preparing a first suspension concentrate composition comprising the dithiocarbamate fungicide and the polyelectrolyte, and (ii) combining the first suspension concentrate composition from step (i) with a strobilurin fungicide to obtain the SC composition of the present invention.

In some embodiments, the strobilurin fungicide in step (ii) is in the form of a SC composition when combined with the suspension concentrate composition from step (i).

In some embodiments, the suspension concentrate comprising the strobilurin fungicide is prepared prior to combining it with the first suspension concentrate of step (i).

The present invention provides a process for preparing a suspension concentrate (SC) composition of the present invention comprising (i) preparing a first suspension concentrate composition comprising the dithiocarbamate fungicide and the polyelectrolyte, and (ii) combining the first suspension concentrate composition from step (i) with the azole fungicide and the strobilurin fungicide to obtain the SC composition of the present invention.

In some embodiments, the azole fungicide and/or the strobilurin fungicide in step (ii) is in the form of a SC composition when combined with the suspension concentrate composition from step (i).

In some embodiments, the suspension concentrate comprising the azole and the strobilurin fungicide is prepared prior to combining it with the first suspension concentrate of step (i).

In some embodiments, the first suspension concentrate composition has a concentration of the dithiocarbamate fungicide between 0.01% to 45% by weight based on the total weight of the first suspension concentrate composition. In some embodiments, the first suspension concentrate composition has a concentration of the dithiocarbamate fungicide of more than 30% by weight based on the total weight of the composition. In some embodiments, the first suspension concentrate composition has a concentration of the dithiocarbamate fungicide of between 30-45% by weight based on the total weight of the composition.

In some embodiments, the first suspension concentrate composition has a concentration of the dithiocarbamate fungicide of between 350 and 600 g/L. In some embodiments, the first suspension concentrate composition has a concentration of the dithiocarbamate fungicide of about 500 g/L.

In some embodiments, the first suspension concentration composition of step (i) is prepared by (a) providing an aqueous composition of a polycation, (b) mixing a dithiocarbamate fungicide into the aqueous composition while keeping the pH of the mixture between pH=3-6, preferably between 3-4, by addition of an acid, and (c) adding at least one dispersant. In some embodiments, the dispersant is an anionic surfactant.

The present invention also provides a process for preparing a suspo-emulsion (SE) composition comprising a polyelectrolyte, a dithiocarbamate fungicide and additional fungicide(s), comprising (i) preparing an emulsifiable concentrate comprising the additional fungicide(s), (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition. Alternatively, one can prepare an EC then emulsify in water to get O/W emulsion (EW).

The present invention also provides a process for preparing a suspo-emulsion (SE) composition comprising a polyelectrolyte, a dithiocarbamate fungicide and an azole fungicide, comprising (i) preparing an emulsifiable concentrate comprising the azole fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

The present invention also provides a process for preparing a suspo-emulsion (SE) composition comprising a polyelectrolyte, a dithiocarbamate fungicide and a strobilurin fungicide, comprising (i) preparing an emulsifiable concentrate comprising the strobilurin fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

The present invention also provides a process for preparing a suspo-emulsion (SE) composition comprising a polyelectrolyte, a dithiocarbamate fungicide, an azole fungicide and a strobilurin fungicide, comprising (i) preparing an emulsifiable concentrate comprising the azole fungicide and the strobilurin fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

In some embodiments, at least one agriculturally acceptable additive is added during step (i), step (ii), step (iii), and/or step (iv).

In some embodiments, at least one agriculturally acceptable additive is added to the SE composition obtained after step (iv) of the process.

The present invention also provides a process for preparing a suspo-emulsion (SE) composition comprising a polyelectrolyte, a dithiocarbamate fungicide and additional fungicide(s), comprising (i) preparing a solution of the additional fungicide and optionally additional fungicide in water immiscible carrier and additional co-solvent, (ii) preparing an emulsion of the solution of step (i), (iii) adding the polyelectrolyte with co-solvent and acid, and (iv) adding the dithiocarbamate fungicide and at least one dispersant to obtain the SE composition.

The present invention also provides a process for preparing a suspo-emulsion (SE) composition comprising a polyelectrolyte, a dithiocarbamate fungicide and an azole fungicide, comprising (i) preparing a solution of the azole fungicide and optionally additional fungicide in water immiscible carrier and additional co-solvent, (ii) preparing an emulsion of the solution of step (i), (iii) adding the polyelectrolyte with co-solvent and acid, and (iv) adding the dithiocarbamate fungicide and at least one dispersant to obtain the SE composition.

The present invention also provides a process for preparing a suspo-emulsion (SE) composition comprising a polyelectrolyte, a dithiocarbamate fungicide and a strobilurin fungicide, comprising (i) preparing a solution of the strobilurin fungicide and optionally additional fungicide in water immiscible carrier and additional co-solvent, (ii) preparing an emulsion of the solution of step (i), (iii) adding the polyelectrolyte with co-solvent and acid, and (iv) adding the dithiocarbamate fungicide and at least one dispersant to obtain the SE composition.

The present invention also provides a process for preparing a suspo-emulsion (SE) composition comprising a polyelectrolyte, a dithiocarbamate fungicide, an azole fungicide and a strobilurin fungicide, comprising (i) preparing a solution of the azole fungicide and the strobilurin fungicide and optionally additional fungicide in water immiscible carrier and additional co-solvent, (ii) preparing an emulsion of the solution of step (i), (iii) adding the polyelectrolyte with co-solvent and acid, and (iv) adding the dithiocarbamate fungicide and at least one dispersant to obtain the SE composition.

The present invention also provides a process for preparing a suspo-emulsion (SE) composition of the present invention comprising the steps: (1) preparing a solution of the azole fungicide and optionally additional fungicide in water immiscible carrier and additional co-solvent, (2) preparing an emulsion of the solution of step (1), (3) adding chitosan with co-solvent and acid, and (4) adding mancozeb and lignosulfonate.

The present invention also provides a process for preparing a suspo-emulsion (SE) composition of the present invention comprising the steps: (1) preparing a solution of the strobilurin fungicide and optionally additional fungicide in water immiscible carrier and additional co-solvent, (2) preparing an emulsion of the solution of step (1), (3) adding chitosan with co-solvent and acid, and (4) adding mancozeb and lignosulfonate.

The present invention also provides a process for preparing a suspo-emulsion (SE) composition of the present invention comprising the steps: (1) preparing a solution of the azole fungicide and the strobilurin fungicide and optionally additional fungicide in water immiscible carrier and additional co-solvent, (2) preparing an emulsion of the solution of step (1), (3) adding chitosan with co-solvent and acid, and (4) adding mancozeb and lignosulfonate.

In some embodiments, the emulsifiable concentrate (EC) is solution of azole, strobilurin and/or any other fungicide different from mancozeb in a water-immiscible carrier, optionally comprising co-solvent.

In some embodiments, the process further comprises adding an agricultural acceptable additive.

In some embodiments, the anionic surfactant dispersant can be added parallel to the mancozeb.

In some embodiments, preparing the solution/EC of the azole and/or strobilurin includes heating for complete dissolving of the azole and/or strobilurin.

In some embodiments, heating is done to a temperature of 40-60° C.

In some embodiment, heating is done to 60° C. for up to about 30 min.

The present invention also provides a macromolecular complex produced using any one of the processes or methods described herein. Macromolecular complexes can also be made as described in PCT/IB2020/055089.

The present invention also provides a process for producing a composition comprising any one of the macromolecular complexes described herein and an agriculturally acceptable additive, wherein the process comprises the following steps:
(a) obtaining the macromolecular complex,
(b) mixing the macromolecular complex obtained in step (a) with agriculturally acceptable additive, and
(c) thereby producing the composition comprising the macromolecular complex and the agriculturally acceptable additive.

The present invention also provides a composition prepared using any one of the processes described herein.

### 4.5 Processes for Preparing Macromolecular Complexes

The invention further provides a process for producing a macromolecular complex according to the invention, comprising (a) providing an aqueous composition of a polycation, (b) mixing a dithiocarbamate fungicide into the aqueous composition, while keeping the pH of the mixture between pH=3-6, preferably between 3-4, by addition of an acid, and (c) thereby producing a macromolecular complex of a polycation and a dithiocarbamate fungicide.

The invention further provides a process for producing a macromolecular complex, comprising the following steps:
(a) providing an aqueous composition of a polycation,
(b) mixing a dithiocarbamate fungicide into the aqueous composition, while keeping the pH of the mixture between pH=3-6, by addition of an acid, and
(c) thereby producing a macromolecular complex of a polycation and a dithiocarbamate fungicide in an aqueous composition.

In some embodiments, the aqueous composition of step (c) has neutral zeta potential, where neutral zeta potential refers to ±10 Mv, preferable ±5 Mv In some embodiments, the polycation is chitosan. In some embodiments, the polycation is PAA.

In some embodiments, the dithiocarbamate fungicide is mancozeb.

In some embodiments, step (b) comprises keeping the pH of the mixture between 3-4.

In some embodiments, the macromolecular complex is substantially free of polyanion and step (b) comprises obtaining a batch of the dithiocarbamate fungicide that is substantially free of polyanion and mixing the batch with the aqueous composition of step (a). In some embodiments, the macromolecular complex is free of polyanion and step (b) comprises obtaining a batch of the dithiocarbamate fungicide that is free of polyanion and mixing the batch with the aqueous composition of step (a). In some embodiments, the macromolecular complex comprises mancozeb and is free of polyanion and step (b) comprises obtaining a batch of mancozeb that is free of polyanion and mixing the batch with the aqueous composition of step (a). In some embodiments, the macromolecular complex comprises mancozeb and is free of lignosulfonate and step (b) comprises obtaining a batch of mancozeb that is free of lignosulfonate and mixing the batch with the aqueous composition of step (a).

In some embodiments, the process further comprises a step of milling or grinding the resultant macromolecular complex to reduce their particle size to any of the particle sizes described herein.

Said methods or processes for producing a composition according to the invention may further comprise a step of milling or grinding the resultant macromolecular complex to reduce their particle size to an average particle size (volume based) d50 below 2 micron.

In some embodiments, the process further comprises milling or grinding the resultant macromolecular complex to reduce their particle size such that the particles have a d50 of 1-2 microns. In some embodiments, the process further comprises milling or grinding the resultant macromolecular complex to reduce their particle size such that the particles have a d90 of 2-3 microns.

In some embodiments, the dithiocarbamate fungicide is milled before it is added to the composition. In some embodiments, the azole fungicide is milled before it is added to the composition. In some embodiments, the strobilurin fungicide is milled before it is added to the composition. In general, any of the fungicides use in the composition of the present invention may be milled before it is added to the composition.

Keeping or adjusting a pH can be achieved by adding acid, base and buffer. Said acid may include, but is not limited to, hydrochloric acid.

Said aqueous composition of a polycation can be generated by solubilizing the polycation in an aqueous acidic solution comprising an acid such as, for example, lactate, hydrochloric acid, phosphorous acid and/or ascorbic acid. The amount of acid that is required to solubilize the polycation depends on the polycation, as is known to a skilled person. For example, for solubilizing chitosan, in general, about 6 ml 37% HCl is required to obtain a solution of 10 grams chitosan in 1 liter of water. As an alternative, a polycation is dissolved in an aqueous solution, preferably water, for example by gently shaking at 20-23° C. overnight, whereby a salt such as sodium chloride is preferably added to the aqueous solution at a concentration between 1 mM and 1 M, preferably about 100 mM.

During mixing, the temperature is preferably kept between 0° C. and 100° C., more preferred between 10° C. and 60° C., more preferred kept at ambient temperature (15-25° C.). The resulting mixture is preferably stirred during formation of the macromolecular complex. Following formation of the macromolecular complex, a dispersant and/or a wetting agent such as butyl block copolymer is preferably added.

The relative amounts of a polycation and a dithiocarbamate fungicide that are combined in step b) of a method according to the invention is between 1:5 and 1:300 (w/w), more preferred in a ratio between 1:20 and 1:200, more preferred in a ratio between 1:60 and 1:80 (w/w).

The final pH value of the resulting composition may be adjusted to a pH value of between 3-12, more preferred between 4-9, most preferred between 5-8.

Said macromolecular complex of a polyelectrolyte and a negatively charged, ionizable, protonated, polar, or delta-charged bioactive ingredient which is a dithiocarbamate fungicide, preferably zinc; manganese(2+); N-[2-(sulfidocarbothioylamino)ethyl]carbamodithioate may be characterized as a regular, homogeneous precipitate that can be formulated as a stable suspension or emulsion concentrate. For this, the macromelecular complex may be milled or grinded, for example using a Dynomill®, to reduce the particle size of the resultant macromolecular complex particles. The resultant macromolecular complex particles preferably have a d50 below 5 microns (volume based), preferably 2 microns or less. Said low d50 value improves their morphology, and may increase their wettability, dispersability and stability of the composition as well as adhesiveness to plant surface with improved rainfastness.

Said macromolecular complex improves the biological efficacy of the dithiocarbamate fungicide such that less of the dithiocarbamate fungicide is required to achieve control of agricultural pests, when compared to the same dithiocarbamate fungicide that is not complexed into a macromolecular complex. In addition, the inclusion in a macromolecular complex may improve rainfastness and provides longer duration by slow release of the dithiocarbamate fungicide, as is demonstrated in the examples.

The present invention also provides a macromolecular complex produced using any one of the processes or methods described herein.

In some embodiments, the macromolecular complex is obtained by preparing the macromolecular complex using any one of the methods and processes disclosed herein.

As used herein, the term “additive” refers to an inert component of a composition. Agriculturally acceptable additive includes agriculturally acceptable carrier.

Agriculturally acceptable additives are described herein above. Any one or any combination of the agriculturally acceptable additives described herein above may be mixed with the macromolecular complex to produce the corresponding composition.

In some embodiments, the agriculturally acceptable additive a dispersant and step (b) comprises mixing the dispersant with the macromolecular complex obtained in step (a).

In some embodiments, the dispersant is lignosulfonate.

In some embodiments, the composition comprises a stabilizer, anti-foam agent, antifreezing agent, surfactant, wetting agent, preservative and/or rheology modifier, and step (b) comprises mixing the stabilizer, anti-foam agent, antifreezing agent, surfactant, wetting agent, preservative and/or rheology modifier with the macromolecular complex obtained in step (a).

In some embodiments the composition comprises water and step (b) comprises mixing the water with the macromolecular complex obtained in step (a).

In some embodiments, wherein the surfactant is anionic, the surfactant is added after the polycation is mixed with the dithiocarbamate fungicide. In some embodiments, wherein the surfactant is anionic, the surfactant is added to the polycation in parallel to the dithiocarbamate fungicide. In some embodiments, wherein the surfactant is nonionic, the surfactant can be added at any stage of the formulating process.

In some embodiments, the formulating process refer to (a) preparing the macromolecular complex comprising polycation and dithiocarbamate fungicide and (b) adding the acceptable inert agricultural additive such as wetting agent, anti-foaming agent and rheology modifier.

In some embodiments, a co-solvent is added at step (a) of preparing the macromolecular complex.

### 4.6 Methods of Use

The invention also provides a method of treating a plant, or a part of a plant, against a pathogen, comprising contacting the plant, part of the plant, locus of the pathogen, soil, and/or an area in which pest infestation is to be prevented with any one of the combinations, compositions, and/or delivery systems described herein.

In some embodiments, treating comprises protecting the plant, or a part of the plant, against the pathogen.

In some embodiments, treating comprises preventing, reducing and/or eliminating the presence of a pathogen on the plant, or a part of the plant.

In some embodiments, treating comprises controlling diseases caused by phytopathogenic fungi in the plant, or a part of the plant.

In some embodiments, treating comprises improving the control of the disease caused by phytopathogenic fungi in the plant, or a part of the plant.

In some embodiments, treating comprises prolonging a controlling effect of the dithiocarbamate fungicide.

The invention also provides a method of increasing crop yield comprising contacting the plant, part of the plant, locus of the pathogen, soil, and/or an area in which pest infestation is to be prevented with any one of the combinations, compositions, and/or delivery systems described herein.

The invention also provides a method of improving plant vigor comprising contacting the plant, part of the plant, locus of the pathogen, soil, and/or an area in which pest infestation is to be prevented with any one of the combinations, compositions, and/or delivery systems described herein.

The present invention also provides a method for pest control by preventive, curative or persistence treatments of a plant disease caused by phytopathogenic fungi comprising contacting a plant, a locus thereof or propagation material thereof with an effective amount of any one of the combinations, compositions, or delivery systems disclosed herein.

The present invention also provides use of any one of the combinations, compositions, and/or delivery systems described herein for treating a plant, or a part of a plant, against a pathogen.

The present invention also provides use of any one of the combinations, compositions, and/or delivery systems described herein for increasing crop yield.

The present invention also provides use of any one of the combinations, compositions, and/or delivery systems described herein for improving plant vigor.

In some embodiments, the method or use of the macromolecular complex, comprising a dithiocarbamate fungicide and a polycation, or a delivery system or composition thereof may result in a reduced rate of application of the dithiocarbamate fungicide.

The terms “reduced rate of application” and “increasing biological activity” may refer to a rate of application that is more than 20%, preferably more than 50%, reduced, when compared to the rate of application of the same dithiocarbamate fungicide as a free dithiocarbamate fungicide.

Said reduced rate of application may refer to an application rate of 5 mg dithiocarbamate fungicide (a.i.)/ha to 2.5 kg a.i./ha, preferably 1 g a.i./ha to 2 kg a.i./ha.; such as a rate of 750 g a.i./ha.; a rate of 605 g a.i./ha., a rate of 500 g a.i./ha.

In some embodiments, the combination, composition, and/or delivery system is applied at an amount of 0.01-5 g/ha of the dithiocarbamate fungicide. In some embodiments, the combination, composition, and/or delivery system is applied at an amount of 0.01-3 g/ha of the dithiocarbamate fungicide. In some embodiments, the combination, composition, and/or delivery system is applied at an amount of 0.01-2 g/ha of the dithiocarbamate fungicide. In some embodiments, the combination, composition, and/or delivery system is applied at an amount of 0.01-1 g/ha of the dithiocarbamate fungicide.

In some embodiments, the combination, composition, and/or delivery system is applied at an amount of 0.01-5 g/ha of mancozeb. In some embodiments, the combination, composition, and/or delivery system is applied at an amount of 0.01-3 g/ha of mancozeb. In some embodiments, the combination, composition, and/or delivery system is applied at an amount of 0.01-2 g/ha of mancozeb. In some embodiments, the combination, composition, and/or delivery system is applied at an amount of 0.01-1 g/ha of mancozeb.

In some embodiments, the combination, composition, and/or delivery system is applied at an amount of 0.018 g/ha of mancozeb. In some embodiments, the combination, composition, and/or delivery system is applied at an amount of 0.97 g/ha of mancozeb. In some embodiments, the combination, composition, and/or delivery system is applied at an amount of 0.39 g/ha of mancozeb. In some embodiments, the combination, composition, and/or delivery system is applied at an amount of 1.56 g/ha of mancozeb.

A macromolecular complex according to the invention is suitable for the control of pests that are encountered in horticulture, agriculture, and forestry. The macromolecular complexes are active against normally sensitive and resistant pest species and during all or individual stages of development. Prior to use, a composition comprising a macromolecular complex according to the invention is preferably dissolved or dispersed in water, or diluted with water, to provide an aqueous composition comprising between 0.001 and 10 w/v % of the dithiocarbamate fungicide. If required, an agriculturally acceptable carrier such as a sticking agent is added to the diluted aqueous composition.

A composition according to the invention is preferably diluted 2-5000 times, preferably about 200 times, with an aqueous solvent, preferably water, to contain between 0.0001 and 10% (w/v) of the dithiocarbamate fungicide, prior to contacting a plant, plant part or soil with the composition.

To control agricultural pests, the invention provides a use of a composition comprising a macromolecular complex according to the invention for the protection of a plant, or a part of a plant, against a pathogen. In order to achieve this effect, said plant or plant part, or a soil, is contacted with said composition, including a diluted aqueous composition. Said composition is used, for example, to control powdery mildew and downy mildew infections on food/feed crops, including tree fruits, vegetable crops, field crops, grapes, ornamental plants, and sod farms. Further use, for example, is to control scab, including common scab, apple scab and black scab on potatoes, pear scab, and powdery scab, brown rot of peaches, currant and gooseberry leaf spot, peanut leafspot, and mildew on roses. Other uses include protection of greenhouse grown flowers and ornamentals, home vegetable gardens and residential turf. In addition, said composition, including a diluted aqueous composition, may be contacted with isolated fruits, nuts, vegetables, and/or flowers.

For said use and said methods, the composition, including a diluted aqueous composition, is preferably sprayed over a plant, or part thereof. Spraying applications using automatic systems are known to reduce labor costs and are cost-effective. Methods and equipment well-known to a person skilled in the art can be used for that purpose. The composition, including diluted aqueous composition, can be regularly sprayed, when the risk of infection is high. When the risk of infection is lower, spray intervals may be longer.

Other methods suitable for contacting plants or parts thereof with a composition of the invention are also a part of the present invention. These include, but are not limited to, dipping, watering, drenching, introduction into a dump tank, vaporizing, atomizing, fogging, fumigating, painting, brushing, misting, dusting, foaming, spreading-on, packaging and coating (e.g. by means of wax or electrostatically). In addition, the composition, including a diluted aqueous composition, may be injected into the soil.

For example, a plant of part thereof may be coated with a diluted aqueous composition comprising a dithiocarbamate fungicide according to the invention by submerging the plant or part thereof in a diluted aqueous composition to protect the plant of part thereof against a pathogen and/or to prevent, reduce and/or eliminate the presence of a pathogen on a plant, or a part of a plant. A preferred part of a plant that is coated with a composition according to the invention, or with a dilution thereof, is seed. A further preferred part of a plant that is coated with a composition according to the invention, or with a dilution thereof, is leaf. A further preferred part of a plant that is coated with a composition according to the invention, or with a dilution thereof, is a fruit, preferably a post-harvest fruit such as, for example, a citrus fruit such as orange, mandarin and lime, a pome fruit such as apple and pear, a stone fruit such as almond, apricot, cherry, damson, nectarine, tomato, watermelon, a tropical fruit such as banana, mango, lychee and tangerine. A preferred fruit is a citrus fruit, such as orange and/or a tropical fruit such as banana.

In some embodiments, the pathogen is phytopathogenic fungi.

In some embodiments, the fungus is one of Leaf Blotch of Wheat (Mycosphaerella graminicola; anamorph: Septoria tritici), Wheat Brown Rust (Puccinia triticina), Stripe Rust (Puccinia striiformis f sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f sp. tritici), Powdery Mildew of Barley (Blumeria graminis f. sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

In some embodiments, the pesticide is applied at a rate effective for controlling a pest. In some embodiments, the pesticide is applied at a rate effective for preventing infestation of the pest. In some embodiments, the pesticide is applied at a rate effective for curing infestation of the pest.

In some embodiments, a method of the invention is effective for preventing infestation of a pest. In some embodiments, the method is effective for curing infestation of the pest. In some embodiments, the method is effective for increasing the pesticidal activity of the pesticide, wherein the pesticide is which is dithiocarbamate fungicide. In some embodiments, the method is effective for prolonging the pesticidal effect of the pesticide, wherein the pesticide is which is dithiocarbamate fungicide. In some embodiments, the method is effective for increasing uptake of the pesticide by the plant, increasing penetration of the pesticide into the plant, increasing retention of the pesticide by the plant, and/or increasing the bioavailability of the pesticide to the plant, wherein the pesticide is which is dithiocarbamate fungicide.

In some embodiments, a method of the invention is effective for decreasing the half maximal effective concentration (EC50) of the dithiocarbamate fungicide. In some embodiments, the method is effective for decreasing the EC50 by at least 10%. In some embodiments, the method is effective for decreasing the EC50 by at least 25%. In some embodiments, the method is effective for decreasing the EC50 by at least 35%. In some embodiments, the method is effective for decreasing the EC50 by at least 50%.

In some embodiments, a method of the invention is effective for decreasing the LC50 of the dithiocarbamate fungicide. In some embodiments, the method is effective for decreasing the LC50 by at least 10%. In some embodiments, the method is effective for decreasing the LC50 by at least 25%. In some embodiments, the method is effective for decreasing the LC50 by at least 50%. In some embodiments, the method is effective for decreasing the LC50 by at least 75%. In some embodiments, the method is effective for decreasing the LC50 by at least 90%.

In some embodiments, a method of the invention is effective for decreasing the LC90 of the dithiocarbamate fungicide. In some embodiments, the method is effective for decreasing the LC90 by at least 10%. In some embodiments, the method is effective for decreasing the LC90 by at least 25%. In some embodiments, the method is effective for decreasing the LC90 by at least 50%. In some embodiments, the method is effective for decreasing the LC90 by at least 75%. In some embodiments, the method is effective for decreasing the LC90 by at least 90%.

In some embodiments, the combination, composition or delivery system is sprayed over a plant or a part of a plant.

In some embodiments, the plant part is leaf, seed or/and fruit.

In some embodiments, the combination, composition or delivery system is applied pre-emergence. In some embodiments, the combination, composition or delivery system is applied post-emergence.

In some embodiments, the combination, composition or delivery system is applied as a foliar application. In some embodiments, the combination, composition or delivery system is applied as a soil application.

In some embodiments, the combination, composition or delivery system is tank mixed with an additional agrochemical. In some embodiments, the combination, composition or delivery system is applied sequentially with the additional agrochemical.

In some embodiments, the combination, composition or delivery system is tank mixed with an additional adjuvant. In some embodiments, the combination, composition or delivery system is applied sequentially with an additional adjuvant.

In some embodiments, the adjuvant is selected from group consisting of plant oil derivatives. In some embodiments, the plant oil derivative is a vegetable oil derivative. In some embodiments, the vegetable oil derivative is a soybean oil methyl ester.

Each embodiment disclosed herein is contemplated as being applicable to each of the other disclosed embodiments. Thus, all combinations of the various elements described herein are within the scope of the invention. In addition, the elements recited in macromolecular complex embodiments can be used in the composition, method, use, process, delivery system embodiments described herein and vice versa.

The invention is illustrated by the following examples without limiting it thereby.

### EXPERIMENTAL SECTION

### Example 1. SC Composition of Mancozeb, Prothioconazole and Picoxystrobin

TABLE 1
SC Composition of Mancozeb, Prothioconazole and Picoxystrobin

| Ingredient | g/L | % w/w |
|---|---|---|
| Mancozeb (as 87%) | 459.8 | 35.4 |
| Prothioconazole (as 99.6%) | 38.2 | 2.97 |
| Picoxystrobin (as 99%) | 29.3 | 2.28 |
| Chitosan | 6.5 | 0.52 |
| Ecosurf EH-3 | 2.0 | 0.14 |
| Reax 88 A | 68.9 | 5.3 |
| Acetic acid | 3.0 | 0.23 |
| Sag 1572 | 5.1 | 0.39 |
| Propylene glycol | 47.8 | 3.68 |
| Proxel GXL | 0.87 | 0.07 |
| Methyl soyate | 26.5 | 2.04 |
| Supragil WP | 2.0 | 0.15 |
| AgRH 23 (2% solution) | 32.5 | 2.5 |
| Water | 577.5 | 44.43 |
| Total: | 1300 | 100 |

TABLE 2
Storage Stability of the SC Composition of Mancozeb,
Prothioconazole and Picoxystrobin.

| | T zero | 2 Weeks 54° C. |
|---|---|---|
| pH | 5.3 | 6.8 |
| Density (g/mL) | 1.3 | 1.3 |
| Particle size d₉₀ (μm) | 4.9 | 6.6 |
| Viscosity, 12 RPM (cP) | 1400 | 2400 |

The composition of Table 1 was prepared using the following procedure:
1. Prepare a SC Composition A comprising 500 g/L mancozeb (Table 3):
   i) Add water to vessel.
   ii) Mix the chitosan and propylene glycol by low shear and add them to the reactor while stirring.
   iii) Add acetic acid to the reactor and mix until chitosan fully dissolve
   iv) Start stirring by Low Shear and add Mancozeb gradually during stirring.
   v) Add Reax 88A after feeding all Mancozeb or gradually during feeding Mancozeb tech. to reduce viscosity.
   vi) After feeding all mancozeb and Reax 88A add Sag 1572, and Proxel GXL and mix by stirring
   vii) Pass suspension during Supraton to reduce viscosity
   viii) Add AgRH 23 2% solution and mix by stirring
2. Prepare an SC Composition B comprising 219.6 g/L prothioconazole and 167.6 g/L picoxystrobin (Table 4):
   i) Add water, propylene glycol, Supragil WP, EH-3 surfactant, Reax 88A and mixed until the solution is homogenous
   ii) Slowly charged prothioconazole tech. and picoxystrobin tech. while shearing with high shear until the solution is homogenous.
   iii) Add SAG 1572 and mix until the solution is homogenous
   iv) Mill the premix until D90<6 vim
   v) Add Ag/RH 23 2% sol. to get viscosity about 1000-2400 cP and rest of water
3. Prepare the SC composition of mancozeb, prothioconazole and picoxystrobin by combining Composition A and Composition B such that the final SC composition has 82.45% of Composition A (mancozeb 500 SC) and 15.55% of Composition B (Prothioconazole 219.6 and Picoxystrobin 167.6 SC).
   i) Add Composition A (Mancozeb 500 SC) to vessel (82.45%),
   ii) Add methyl soyate to vessel and mix until the solution is homogenous (2%),
   iii) Add Composition B (Prothioconazole 219.6 and Picoxystrobin 167.6 SC) to vessel and mix until the solution is homogenous (15.55%)

TABLE 3
Composition A - Mancozeb 500 SC

| Ingredient | g/L | % w/w |
|---|---|---|
| Mancozeb (as 87%) | 574.7 | 44.2 |
| Chitosan | 8.1 | 0.63 |
| Reax 88 A | 76.2 | 5.9 |
| Acetic acid | 3.8 | 0.3 |
| Sag 1572 | 5.1 | 0.4 |
| Propylene glycol | 53.3 | 4.1 |
| Proxel GXL | 1.0 | 0.1 |
| AgRH 23 (2% solution) | 20.4 | 1.6 |
| Water | 557.4 | 42.9 |
| Total: | 1300 | 100 |

TABLE 4
Composition B - Prothioconazole
219.6 and Picoxystrobin 167.6 SC

| Ingredient | g/L | % w/w |
|---|---|---|
| Prothioconazole (As 99.6%) | 220.5 | 19.3 |
| Picoxystrobin (As 99%) | 169.3 | 14.9 |
| Supragil WP | 11.5 | 1.0 |
| Ecosurf EH-3 | 11.5 | 1.0 |
| Reax 88 A | 46 | 4.0 |
| Sag 1572 | 11.5 | 1.0 |
| Propylene glycol | 30 | 2.6 |
| AgRH 23 (2% solution) | 9.7 | 0.9 |
| Water | 630 | 55.3 |
| Total: | 1140 | 100 |

### Example 2. SE Composition of Mancozeb, Prothioconazole and Picoxystrobin

TABLE 5
SE composition of Mancozeb, Prothioconazole and Picoxystrobin

| Ingredients | % w/w | |
|---|---|---|
| Water | 33.49 | Oil-in- water |
| Porthioconazole | 3.03 | emulsion |
| (99.7@3.02%) | | portion |
| Picoxystrobin | 2.31 | |
| (99.9@2.31%) | | |
| Solvesso200 | 9.00 | |
| Rhodiasolv Match 111 | 2.50 | |
| Emulsogen TS-100 | 0.50 | |
| SAG 1572 | 0.40 | |
| Chitosan | 0.50 | |
| Propylene glycol | 4.00 | |
| Acetic acid | 0.30 | |
| Mancozeb (85.8% @ 31.65) | 36.89 | |
| Reax 88B | 6.00 | |
| Proxel GXL | 0.08 | |
| AgRH 23 (2%) | 1.00 | |
| Total | 100.00 | |

TABLE 6
Storage Stability of the SE Composition of Mancozeb,
Prothioconazole and Picoxystrobin.

| | T zero | 2 Weeks 54° C. |
|---|---|---|
| pH (1% in water) | 8.1 | 8.1 |
| Density (g/mL) | 1.28 | 1.28 |
| Particle size d₉₀ (μm) | 6.9 | 7.7 |
| Viscosity, 12 RPM (cP) | 1700 | 2250 |

The composition of Table 5 was prepared using the following procedure:

The oil portion was prepared by mixing solvent (Solvesso 200), cosolvent (Rhodiasolv Match 111), technicals (Picoxystrobin, Prothioconazole) and emuslfier (Emulsogen TS 100) together and stirring until the solution became clear. This oil portion was added to water containing 50% of total defoamer (SAG1572) content in the composition at high shear about 800-1000 rpm to form an oil in water emulsion. Alternatively, antifoam can be added after the high shear step instead. Chitosan dispersed in propylene glycol was added to the oil-in-water emulsion at low shear, followed by addition of acetic acid to dissolve chitosan. Later, 60% of total quantity of mancozeb technical was added slowly while stirring at about 1000 rpm followed by SAG1572 (remaining quantity), Reax 88B(10% of total quantity), mancozeb technical (10% of total quantity), Reax 88B (40% of total quantity), remaining mancozeb, Reax 88 B and Proxel GXL in sequence at low shear and mixed well.

The above suspension mixture was homogenized for 10 min in high shear mixer until it passes the 200 BSS wet sieve. Later rheology modifier, Agrho® Pol 23, was added to obtain a viscosity-adjusted suspoemulsion.

### Example 3. SC Composition of Mancozeb, Tebuconazole and Picoxystrobin

TABLE 7
SC Composition of Mancozeb, Tebuconazole and Picoxystrobin

| Ingredient | g/L | % w/w |
|---|---|---|
| Tap water | 601.8 | 46.3% |
| Propylen glycol | 42.6 | 3.3% |
| Chitosan | 5.1 | 0.4% |
| Acetic acid (Galcial) | 3.0 | 0.2% |
| Triton HW-1000 | 1.0 | 0.1% |
| Mancozeb (86.1% - 500 g/L) | 464.6 | 35.8% |
| Silcolapse 432 | 0.9 | 0.07% |
| Reax 88-A | 72.6 | 5.6% |
| SAG 1572 | 4.1 | 0.32% |
| Methyl soyate | 20.3 | 1.6% |
| Stepwet DF-95 | 1.2 | 0.1% |
| Terbuconazole 98% | 33.4 | 2.6% |
| Picoxystrobin 99% | 26.6 | 2.0% |
| acticide MBS | 0.84 | 0.06% |
| AgRH 23 (2% solution) | 22 | 1.7% |
| Total | 1300.0 | 100.0% |

TABLE 8
Storage Stability of the SC Composition of
Mancozeb, Tebuconazole and Picoxystrobin.

| | T zero | 2 Weeks 54° C. |
|---|---|---|
| pH | 5.8 | 7.2 |
| Density (g/mL) | 1.28 | 1.28 |
| Particle size d₉₀ (μm) | 3.7 | 17.7 |
| Viscosity, 12 RPM (cP) | 980 | 1900 |

The composition of Table 7 was prepared using the following procedure:
1. Procedure for preparing Composition A (Table 9):
   i) Suspend Chitosan in propylene glycol
   ii) Add water and start to mix
   iii) Add acetic acid and mix until the chitosan is fully solubilized
   iv) Add Triton HW-100 and mix for additional 5 minutes
   v) Add the active ingredient portion-wise into the solution and mix for an additional 15-30 minutes
   vi) Add Silcolapse 432
   vii) Add Reax 88-A and mix for 15-30 minutes
   viii) Add biocide and and mix for 2 hours. Check the particle size to make sure to have a d50<2.0 μm and a d90 about or below 10 μm
   ix) Add Methyl Soyat and mix
   x) Add AgRH 23 2% solution and mix by stirring
2. Procedure for preparing Composition B (Tebuconazole & Picoxystrobin SC) (Table 10)
   i) Add water, Stepwet DF-95, Reax 88A and mixed until the solution is homogenous
   ii) Slowly charged Tebuconazole tech. and Picoxystrobin tech. while shearing with high shear until the solution is homogenous.
   iii) Add Silcolapse 432 and mix until the solution is homogenous
   iv) Mill the premix until D90<6 μm
3. Procedure for preparing the SC composition of mancozeb, prothioconazole and picoxystrobin by combining Composition A and Composition B
   i) Add Composition A (Mancozeb 500 SC) to vessel (80%),
   ii) Add Composition B (to vessel and mix until the suspension is homogenous

Compositions A and B are shown in Tables 9 and 10. The SC composition of Table 7 is 80% of Composition A and 20% of Composition B

TABLE 9
Composition A - Mancozeb 500 g/L

| Ingredient | g/L | % w/w |
|---|---|---|
| Tap water | 532.9 | 41.0% |
| Propylen glycol | 53.3 | 4.1% |
| Chitosan (Adama) | 6.4 | 0.5% |
| Acetic acid (Galcial) | 3.8 | 0.3% |
| Triton HW-1000 | 1.3 | 0.1% |
| Mancozeb (86.1% - 500 g/L) | 581.0 | 44.7% |
| Silcolapse 432 | 5.1 | 0.4% |
| Reax 88-A | 76.2 | 5.9% |
| Methyl soyat | 25.4 | 2.0% |
| Acticide MBS | 1.0 | 0.1% |
| AgRH 23 (2% solution) | 13.6 | 1.0% |
| Total | 1300.0 | 100.0% |

TABLE 10
Tebuconazole-Picoxystrobin Slurry

| Ingredient | g/L | % w/w |
|---|---|---|
| Tap Water | 923.5 | 71.0% |
| Reax 88A | 65 | 5.0% |
| Stepwet DF-95 | 6.5 | 0.5% |
| Silcolapse 432 | 5 | 0.4% |
| Tebuconazole 98% | 167 | 12.8% |
| Picoxystrobin 99% | 133 | 10.2% |
| Total | 1300 | 100.0% |

### Example 4. SC Composition of Mancozeb and Prothioconazole

TABLE 11
SC Composition of Mancozeb and Prothioconazole

| Ingredient | g/L | % w/w |
|---|---|---|
| Mancozeb (as 87%) | 459.8 | 35.92 |
| Prothioconazole (As 99.6%) | 32.3 | 2.52 |
| Chitosan | 6.5 | 0.51 |
| Ecosurf EH-3 | 1.78 | 0.14 |
| Reax 88 A | 66.3 | 5.2 |
| Acetic acid | 3.0 | 0.23 |
| Sag 1572 | 5.8 | 0.45 |
| Propylene glycol | 47.3 | 3.70 |
| Proxel GXL | 0.87 | 0.07 |
| Methyl soyate | 25.6 | 2.0 |
| Supragil WP | 1.8 | 0.14 |
| AgRH 23 (2% solution) | 32.5 | 2.5 |
| Water | 596.5 | 46.6 |
| Total: | 1280 | 100 |

TABLE 12
Storage Stability of the SC Composition
of Mancozeb and Prothioconazole

| | T zero | 2 Weeks 54° C. |
|---|---|---|
| pH | 5.66 | 6.77 |
| Density (g/mL) | 1.28 | 1.28 |
| Particle size d₉₀ (μm) | 3.99 | 5.12 |
| Viscosity, 12 RPM (cP) | 1330 | 1470 |

The composition of Table 11 was prepared using the following procedure:
1. Prepare a SC Composition A (Table 13) as described in example 1.
2. Prepare an SC Composition B (Table 14) comprising prothioconazole.
   i) Add water, propylene glycol, Supragil WP, EH-3 surfactant and Reax 88A and mix until the solution is homogenous.
   ii) Slowly charge prothioconazole tech. while shearing with high shear until the solution is homogenous.
   iii) Add SAG 1572 and mix until the solution is homogenous.
   iv) Mill the premix until D90<6
   v) Add Ag/RH 23 2% sol. to get viscosity about 1000-1500 cP and rest of water.
3. Prepare the SC composition of mancozeb and prothioconazole by combining Composition A and Composition B such that the final SC composition has 82.45% of Composition A (mancozeb 500 SC) and 15.55% of Composition B (Prothioconazole 206.5 SC).
   i) Add Composition A (Mancozeb 500 SC) to vessel (82.45%),
   ii) Add methyl soyate to vessel and mix until the solution is homogenous (2%),
   iii) Add Composition B (Prothioconazole SC) to vessel and mix until the solution is homogenous (15.55%)

TABLE 13
Composition A - Mancozeb 500 SC

| Ingredient | g/L | % w/w |
|---|---|---|
| Mancozeb (as 87%) | 574.7 | 44.2 |
| Chitosan | 8.1 | 0.63 |
| Reax 88 A | 76.2 | 5.9 |
| Acetic acid | 3.8 | 0.3 |
| Sag 1572 | 5.1 | 0.4 |
| Propylene glycol | 53.3 | 4.1 |
| Proxel GXL | 1.0 | 0.1 |
| AgRH 23 (2% solution) | 20.4 | 1.6 |
| Water | 557.4 | 42.9 |
| Total: | 1300 | 100 |

TABLE 14
Composition B - Prothioconazole 206.5 SC

| Ingredient | g/L | % w/w |
|---|---|---|
| Prothioconazole (As 99.6%) | 207.3 | 19.16 |
| Ecosurf EH-3 surfactant | 11.5 | 1.06 |
| Supragil WP | 11.5 | 1.06 |
| Reax 88 A | 34.5 | 3.19 |
| Sag 1572 | 11.3 | 1.04 |
| Propylene glycol | 30.0 | 2.77 |
| AgRH 23 (2% solution) | 20.7 | 1.91 |
| Water | 755.2 | 69.79 |
| Total: | 1082.0 | 100 |

### Example 5. SE Composition of Mancozeb and Prothioconazole

| | Quantity | |
|---|---|---|
| | to 1 L (gr) | % |
| Prothioconazole tech. 99% | 32.3 | 2.5% |
| TSP-10 tristyrylphenol ethoxylate, | 6.5 | 0.5% |
| 10 | | |
| Solvesso 200 | 116.6 | 9.0% |
| Rhodiasolv Match 111 | 32.4 | 2.5% |
| Total: | 187.7 | 14.5% |
| Soft water | 430.0 | 33.2% |
| EC part from stage 1 | 187.7 | 14.5% |
| Total: | 617.7 | 47.7% |
| EW part from stage 2 | 617.7 | 47.7% |
| Propylene Glycol | 51.8 | 4.0% |
| Chitosan | 6.5 | 0.5% |
| Acetic acid | 3.9 | 0.3% |
| Mancozeb tech | 464.6 | 35.9% |
| Reax 88 B | 77.7 | 6.0% |
| Sag 1572 | 5.2 | 0.4% |
| Proxek GXL | 1.0 | 0.1% |
| Ag/RH23 2% solution | 32.5 | 2.5% |
| Water | 34.0 | 2.6% |
| Total: | 1294.9 | 100.0% |

Prothioconazole tech. 99%
Mancozeb tech., 86.1%
Density (gr/ml) 1.294

### Preparation of Organic Part:

1. Solvesso 200, Rhodiasolv Match 111 were mixed by, optionally, heating up to 60° C. until the solution is homogenous.
2. Prothioconazole tech was added and mixed by heating up to 60° C. until the solution is homogenous.
3. TSP-10 was added and mixed by heating up to 60° C. until the solution is homogenous.

### Preparation of EW Part:

1. EC part was added to water and the emulsion was applied in high shear about 2 min. EW part was stirred until chitosan and Mancozeb tech. was added.

### Preparation of SE Part:

1. Mixed Chitosan in propylene glycol
2. Solution of chitosan was added to EW part and mixed by low shear
3. acetic acid was added and mixed by low shear
4. Mancozeb tech and Reax 88 B gradually were added very slowly during strong mixing by low shear about 1300-1500 RPM and mixed by low shear about 6 hour at 2000 RPM
5. Sag 1572, Proxek GXL, Ag/RH23 2% sol was added and water and mixed by low shear at 1000-1200 RPM

### Example 6. SE Composition of Mancozeb, Tebuconazole and Picoxystrobin

| | Quantity | |
|---|---|---|
| | to 1 L (gr) | % |
| Tebuconazole tech. 98.3% | 33.2 | 2.6% |
| Picoxystrobin tech. 99.0% | 26.6 | 2.1% |
| TSP-10 tristyrylphenol ethoxylate, | 6.5 | 0.5% |
| 10. | | |
| Solvesso 200 | 116.6 | 9.0% |
| Rhodiasolv Match 111 | 32.4 | 2.5% |
| Total: | 215.1 | 16.6% |
| Soft water | 430.0 | 33.2% |
| EC part from stage 1 | 215.1 | 16.6% |
| Total: | 645.1 | 49.8% |
| EW part from stage 2 | 645.1 | 49.8% |
| Propylene Glycol | 51.8 | 4.0% |
| Chitosan | 6.5 | 0.5% |
| Acetic acid | 3.9 | 0.3% |
| Mancozeb tech. | 464.6 | 35.9% |
| Reax 88 B | 77.7 | 6.0% |
| Sag 1572 | 5.2 | 0.4% |
| Proxek GXL | 1.0 | 0.1% |
| Ag/RH23 2% solution | 32.5 | 2.5% |
| Water | 7.0 | 0.5% |
| Total: | 1295.3 | 100.0% |

Tebuconazole tech. 98.3% 98.3%
Picoxystrobin tech. 99.0% 99.0%
Mancozeb tech., 86.1% 86.1%
Density (gr/ml) 1.295

### Preparation of EC Part:

1. Solvesso 200, Rhodiasolv Match 111 were mixed and heated up to 60° C. until the solution is homogenous
2. Tebuconazole tech. and Picoxystrobin tech. were added to the solvents mixture at step 1 and mixed by heating up to 60° C. until the solution is homogenous
3. TSP-10 was added and mixed by heating up to 60° C. until the solution is homogenous.

### Preparation of EW Part:

1. EC part was added to water and was applied high shear about 2 min. EW part was stirred until chitosan and Mancozeb tech. was added.

### Preparation of SE Part:

1. Mixed Chitosan in propylene glycol
2. Solution of chitosan was added to EW part and mixed by low shear
3. acetic acid was added and mixed by low shear
4. Mancozeb tech and Reax 88 B gradually added at a very slowly rate during huge mixing by low shear about 1300-1500 RPM and mixed by low shear about 6 hour at 2000 RPM
5. Sag 1572, Proxek GXL, Ag/RH23 2% sol was added and water and mixed by low shear at 1000-1200 RPM

1. A combination comprising (1) a macromolecular complex comprising a dithiocarbamate fungicide and a polyelectrolyte, and (2) an azole fungicide.

2. A composition comprising (1) a polyelectrolyte, (2) a dithiocarbamate fungicide, and (3) at least one agriculturally acceptable carrier.

3. The combination or composition of claim 1 or 2, wherein the polyelectrolyte is a polycation.

4. The combination or composition of claim 3, wherein the polycation is selected from the group consisting of cationic starch, poly(allylamine), chitosan, a chitosan derivative, epsilon-p-L-lysine, DEAE-dextran, or any mixtures thereof.

5. The combination or composition of claim 4, wherein the chitosan derivative is thiolated chitosan, 5-methyl-pyrrolidinone-chitosan, or chitosan oligosaccharide.

6. The combination or composition of claim 5, wherein the polycation ion is chitosan.

7. The composition of any one of claims 2-6, wherein the dithiocarbamate fungicide is in a macromolecular complex with the polyelectrolyte.

8. The combination or composition of claim 1 or 7, wherein the macromolecular complex is characterized by intermolecular, non-covalent interactions between the polyelectrolyte and the dithiocarbamate fungicide.

9. The combination or composition of claim 8, wherein the intermolecular, non-covalent interactions are electrostatic interactions.

10. The combination or composition of claim 9, wherein the electrostatic interactions are ionic interactions, hydrogen bonds, van der Waals forces, or any combination thereof.

11. The combination or composition of claim 10, wherein the van der Waals forces are dipole-dipole interactions.

12. The combination or composition of any one of claim 1 or 7-11, wherein the macromolecular complex is substantially free or free of polyanion.

13. The combination or combination or composition of any one of claims 1-12, wherein the dithiocarbamate fungicide is mancozeb.

14. The combination or composition of any one of claims 1-13, wherein the polyelectrolyte and the dithiocarbamate fungicide are present in the macromolecular complex in a ratio between 1:5 and 1:300 (w/w).

15. The combination or composition of any one of claims 1-14, wherein the polyelectrolyte and the dithiocarbamate fungicide are present in the macromolecular complex in a ration between 1:50 and 1:80.

16. The composition of any one of claims 2-15, wherein the composition further comprises an azole fungicide.

17. The combination or composition of any one of claims 1-16, wherein the azole fungicide is selected from the group consisting of tebuconazole, prothioconazole, and a combination thereof.

18. The combination or composition of any one of claims 1-17, wherein the combination or composition comprises mancozeb and prothioconazole.

19. The combination or composition of any one of claims 1-18, wherein the combination or composition further comprises at least one additional agrochemical.

20. The combination or composition of claim 19, wherein the additional agrochemical is a strobilurin fungicide.

21. The combination or composition of claim 20, wherein the strobilurin fungicide is selected from the group consisting of azoxystrobin, picoxystrobin, and a combination thereof.

22. The combination or composition of any one of claims 1-21, wherein the combination or composition comprises mancozeb, picoxystrobin and prothioconazole.

23. The combination or composition of any one of claims 1-21, wherein the combination or composition comprises mancozeb, picoxystrobin and tebuconazole.

24. The composition of any one of claims 2-23, wherein the composition is a suspension concentrate composition and the agriculturally acceptable carrier is an aqueous carrier.

25. The composition of any one of claims 2-24, wherein the composition is a suspoemulsion composition and the agriculturally acceptable carrier is a combination of an aqueous carrier and a water immiscible carrier.

26. The composition of any one of claims 2-25, wherein the concentration of the dithiocarbamate fungicide in the composition is 35-40% by weight based on the total weight of the composition.

27. The combination or composition of any one of claims 1-26, wherein the composition further comprises at least one agriculturally acceptable additive.

28. The combination or composition of claim 27, wherein the additive is selected from stabilizers, dispersants, solubilizing agents, buffers, acidifiers, defoaming agents, thickeners, drift retardants, surfactant, pigments, wetting agents, safeners, preservatives such as bacteriostats or bactericides, surfactants, antifoams, solvents, co-solvent, oils, light stabilizers, UV absorbers, radical scavengers and antioxidants, adhesives, neutralizers, thickeners, binders, sequestrates, biocides, anti-freeze agents, and any combination thereof.

29. The combination or composition of any one of claims 1-28, wherein the combination or composition comprises at least one dispersant.

30. The combination or composition of claim 29, wherein the dispersant is lignosulfonate.

31. The composition of claim 30, wherein the composition is a suspension concentrate composition and the lignosulfonate is acidic.

32. The composition of claim 30, wherein the composition is a suspoemulsion composition and the lignosulfonate is basic.

33. The combination or composition of any one of claims 30-32, wherein the lignosulfonate has a degree of sulfonation of between 2.5 and 3.5.

34. The combination or composition of claim 33, wherein the lignosulfonate has a degree of sulfonation of 2.9.

35. The combination or composition of any one of claims 30-34, wherein the lignosulfonate has an average molecular weight between 2000 g/mol and 6500 g/mol.

36. The combination or composition of any one of claims 30-35, wherein the lignosulfonate has an average molecular weight of about 3100 g/mol.

37. A delivery system comprising any one of any combinations or compositions of claims 1-36.

38. A method of treating a plant, or a part of a plant, against a pathogen, comprising contacting the plant, part of the plant, locus of the pathogen, soil, and/or an area in which pest infestation is to be prevented with the combination, composition, and/or delivery systems of any one of claims 1-37.

39. The method of claim 38, wherein treating comprises:
a) protecting the plant, or a part of the plant, against the pathogen.
b) preventing, reducing and/or eliminating the presence of a pathogen on the plant, or a part of the plant.
c) controlling diseases caused by phytopathogenic fungi in the plant, or a part of the plant.
d) improving the control of the disease caused by phytopathogenic fungi in the plant, or a part of the plant, and/or
e) prolonging a controlling effect of the dithiocarbamate fungicide.

40. The method of claim 38 or 39, wherein the pathogen is phytopathogenic fungi.

41. The method of claim 40, wherein the fungus is one of Leaf Blotch of Wheat (Mycosphaerella graminicola; anamorph: Septoria tritici), Wheat Brown Rust (Puccinia triticina), Stripe Rust (Puccinia striiformis f. sp. tritici), Scab of Apple (Venturia inaequalis), Blister Smut of Maize (Ustilago maydis), Powdery Mildew of Grapevine (Uncinula necator), Barley scald (Rhynchosporium secalis), Blast of Rice (Magnaporthe grisea), Rust of Soybean (Phakopsora pachyrhizi), Glume Blotch of Wheat (Leptosphaeria nodorum), Powdery Mildew of Wheat (Blumeria graminis f. sp. tritici), Powdery Mildew of Barley (Blumeria graminis f sp. hordei), Powdery Mildew of Cucurbits (Erysiphe cichoracearum), Anthracnose of Cucurbits (Glomerella lagenarium), Leaf Spot of Beet (Cercospora beticola), Early Blight of Tomato (Alternaria solani), and Net Blotch of Barley (Pyrenophora teres).

42. The method of any one of claims 38-41, wherein the combination, composition, and/or delivery system is applied at an amount of 0.01-5 g/ha of the dithiocarbamate fungicide.

43. The method of any one of claims 38-42, wherein the combination, composition or delivery system is applied pre-emergence or post-emergence.

44. The method of any one of claims 38-43, wherein the combination, composition or delivery system is applied as a foliar application or soil application.

45. The method of any one of claims 38-44, wherein the combination, composition or delivery system is tank mixed with an additional agrochemical or adjuvant.

46. The method of any one of claims 38-45, wherein the combination, composition or delivery system is applied sequentially with the additional agrochemical or adjuvant.

47. A method of increasing crop yield comprising contacting the plant, part of the plant, locus of the pathogen, soil, and/or an area in which pest infestation is to be prevented with the combination, composition, and/or delivery system of any one of claims 1-37.

48. A method of improving plant vigor comprising contacting the plant, part of the plant, locus of the pathogen, soil, and/or an area in which pest infestation is to be prevented with the combination, composition, and/or delivery system of any one of claims 1-37.

49. Use of polyelectrolyte for formulating a dithiocarbamate fungicide in presence water and/or azole fungicide.

50. A process for preparing a suspension concentrate (SC) composition comprising a polyelectrolyte, a dithiocarbamate fungicide and an azole fungicide, comprising (i) preparing a first suspension concentrate composition comprising the dithiocarbamate fungicide and the polyelectrolyte, and (ii) combining the first suspension concentrate composition from step (i) with the azole fungicide to obtain the SC composition.

51. A process for preparing a suspension concentrate (SC) composition comprising a polyelectrolyte, a dithiocarbamate fungicide and a strobilurin fungicide, comprising (i) preparing a first suspension concentrate composition comprising the dithiocarbamate fungicide and the polyelectrolyte, and (ii) combining the first suspension concentrate composition from step (i) with the strobilurin fungicide to obtain the SC composition.

52. A process for preparing a suspension concentrate (SC) composition comprising a polyelectrolyte, a dithiocarbamate fungicide, an azole fungicide and a strobilurin fungicide, comprising (i) preparing a first suspension concentrate composition comprising the dithiocarbamate fungicide and the polyelectrolyte, and (ii) combining the first suspension concentrate composition from step (i) with the azole fungicide and the strobilurin fungicide to obtain the SC composition.

53. The process of any one of claims 50-52, wherein the first suspension concentration composition of step (i) is prepared by (a) providing an aqueous composition of a polycation, (b) mixing a dithiocarbamate fungicide into the aqueous composition while keeping the pH of the mixture between pH=3-6, preferably between 3-4, by addition of an acid, and (c) adding at least one dispersant.

54. A process for preparing a suspo-emulsion (SE) composition comprising a polyelectrolyte, a dithiocarbamate fungicide and an azole fungicide, comprising (i) preparing an emulsion comprising the azole fungicide, (ii) adding water the emulsion of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

55. A process for preparing a suspo-emulsion (SE) composition comprising a polyelectrolyte, a dithiocarbamate fungicide and a strobilurin fungicide, comprising (i) preparing an emulsion comprising the strobilurin fungicide, (ii) adding water the emulsion of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

56. A process for preparing a suspo-emulsion (SE) composition comprising a polyelectrolyte, a dithiocarbamate fungicide, an azole fungicide and a strobilurin fungicide, comprising (i) preparing an emulsion comprising the azole fungicide and the strobilurin fungicide, (ii) adding water the emulsion of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

57. A process for preparing a suspo-emulsion (SE) composition comprising a polyelectrolyte, a dithiocarbamate fungicide and additional fungicide(s), comprising (i) preparing a solution of the additional fungicide and optionally additional fungicide in water immiscible carrier and additional co-solvent, (ii) preparing an emulsion of the solution of step (i), (iii) adding the polyelectrolyte with co-solvent and acid, and (iv) adding the dithiocarbamate fungicide and at least one dispersant to obtain the SE composition.

58. A process for preparing a suspo-emulsion (SE) composition comprising a polyelectrolyte, a dithiocarbamate fungicide, an azole fungicide and a strobilurin fungicide, comprising (i) preparing an emulsifiable concentrate comprising the azole fungicide and the strobilurin fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

59. A process for preparing a suspo-emulsion (SE) composition comprising a polyelectrolyte, a dithiocarbamate fungicide and additional fungicide(s), comprising (i) preparing an emulsifiable concentrate comprising the additional fungicide(s), (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

60. A process for preparing a suspo-emulsion (SE) composition comprising a polyelectrolyte, a dithiocarbamate fungicide and an azole fungicide, comprising (i) preparing an emulsifiable concentrate comprising the azole fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.

61. A process for preparing a suspo-emulsion (SE) composition comprising a polyelectrolyte, a dithiocarbamate fungicide and a strobilurin fungicide, comprising (i) preparing an emulsifiable concentrate comprising the strobilurin fungicide, (ii) mixing with water the emulsifiable concentrate of step (i) to prepare an oil-in-water emulsion, (iii) adding the polyelectrolyte to the oil-in-water emulsion of step (ii), and (iv) adding the dithiocarbamate fungicide to the oil-in-water emulsion of step (iii) to obtain the SE composition.
